(19) United States
(12) Patent Application Publication
(10) Pub. No.: US 2002/0107780 A1
(43) Pub. Date: Aug. 8, 2002

(54) Inter-firm transaction method and inter-firm transaction mediation method

(76) Inventors: Tatsuya Suzuki, Yokohama (JP); Toshijiro Ohashi, Chigasaki (JP); Kichie Matsuzaki, Yokohama (JP); Yumiko Sawada, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/842,799

(22) Filed: Apr. 27, 2001

(30) Foreign Application Priority Data
Feb. 6, 2001 (JP) 2001-028983

(51) Int. Cl. G06F 17/60

(52) U.S. Cl. 705/37; 705/1

(57) ABSTRACT

In conventional transactions between firms, it is difficult to make objective, quantitative evaluations in advance of firms with which no past transactions have been performed or of the quality of items supplied by a supplier firm with which few transactions have been made. Thus, a firm will not necessarily be able to negotiate with a firm that can supply high-quality items. As a result, a purchasing firm may not be able to purchase high-quality items efficiently, leading to increases in production costs and shipping details. Also, product quality may be lowered because high-quality items could not be obtained. When global purchasing is to be performed, the majority of negotiations will be with firms with which there have been no past transactions. Thus, there is a need for a system that allows efficient purchasing of high-quality products.

An inter-firm transaction mediation site is set up on the Internet. A quality calculation program is provided over a network to firms desiring transactions. The quality calculation program evaluates product quality in terms of “product specifications” and “production plant conditions,” and a product quality evaluation estimate is made based on these evaluation results. As a result, firms desiring inter-firm transactions can calculate indices indicating quality of the item involved in the transaction as well as indices indicating the capability levels relating to quality achievement for the item involved in the transaction. These can be used as desired transaction conditions.

### FIELD OF THE INVENTION

The present invention relates to an inter-firm transaction method and inter-firm transaction mediation method. More specifically, the present invention relates to a method for performing inter-firm transactions and inter-firm transaction mediation based on a quality level of the item involved in the transaction or on information about the level of capability of the firm providing the item involved in the transaction in achieving quality.

### BACKGROUND OF THE INVENTION

Conventional inter-firm transaction mediation services include inter-firm transaction mediation services that uses the Internet to receive a purchase solicitation request from a purchasing firm and an order request from a firm (supplier firm) that wants to receive the order, and provides support for setting up negotiations between firms. An example is described below.

The firm providing the inter-firm negotiation mediation service sets up a negotiation mediation service site on the Internet. Purchasing firms that want to issue order and supplier firms that want to receive orders register as members of the negotiation mediation site. This site receives supplier solicitation offer information from purchasing firms over the Internet and sends this information to supplier firms that want to receive orders. In response to the offers, the supplier firms submit delivery data and price estimate information to the purchasing firm over the Internet. The purchasing firm selects the entry with the best conditions out of the submitted conditions, and can then enter into negotiations with the supplier firm that submitted these conditions.

In the conventional technology described above, the purchasing firm selects the supplier firm for negotiations on the basis of the delivery date and cost estimation information submitted by the supplier firm. The purchasing firm ultimately determines its transaction partner primarily based on price, delivery date, and quality of the item to be purchased (supplied) by the supplier firm. However, as described above, what is submitted in the estimate from the supplier firm is the price and delivery data information, making it difficult to get prior confirmation of the quality of the item to be received by the purchasing firm. If the purchase is from a supplier firm with which past transactions have taken place, quality information from past products can be used as a basis for evaluations. However, for purchases from firms with which there have been no past transactions, there is no way to easily evaluate the quality of products provided by the firm. This makes it difficult to know beforehand about the quality level of the products provided by the supplier firm and the degree to which the supplier firm can provide quality.

Conventionally, the international quality assurance standards set up by the ISO (International Standardization Organization) referred to as the ISO 9000 series have been known as a way to determine the degree to which a firm can assure quality. In these international standards, twenty elements are required for a “quality system”, which includes production processes and quality assurance structures, that can create and maintain appropriate quality. To cover different product supplier organizations, the ISO 9000 series includes three standards: ISO 9001 (standards to be used when the producer is engaged in design/development, manufacture, installation, and accessory services); ISO 9001 (standards to be used when the design is already provided or is provided by the purchaser or a third party, and the producer is engaged in manufacture, installation, and accessory services); and ISO 9003 (standards to be used when design, manufacture, and other usage have been established over a long period and quality assurance issues need only cover final inspections and final testing).

A firm supplying a product selects one of these three quality standards based on its product supply structure, and the firm requests an inspection from an entity certified by the ISO to determine whether or not a firm's “quality system” meets the standards set forth in the ISO 9000 series. If the certifying entity decides that the firm meets the ISO 9000 series standards, the firm's “quality system” is certified by the ISO as meeting the ISO 9000 series standards, and a certificate is issued.

Whether or not an ISO 9000 series certification has been received is used in some cases to determine the quality assurance level of a firm. Some purchasing firms include ISO 9000 series certification as a condition for firms with which it will engage in transactions.

Another quality standard similar to the ISO 9000 series is the QS-9000 quality standard set forth by United States automobile manufacturers (e.g., the “Big Three” auto makers—Daimler Chrysler, Ford, GM). This is a common quality system standard based on the ISO 9000 series. Suppliers of auto parts and materials to U.S. automobile manufacturers must meet QS-9000 standards. Some purchasing manufacturers require third-party certification for transactions.

Third parties undertaking QS-9000 certification inspect twenty elements required for a product supplier's “quality system”, giving a score for each element. The third-party entity gives certification if the all the evaluated elements meet reference scores set up for each element. The scores for each element, a composite score calculated by dividing the total score by the number of elements, and the like are reported as the inspection results. The client purchasing automobile parts/materials take the QS-9000 inspection results into consideration when determining a supplier.

In the conventional transaction between firms described above, it is difficult to obtain objective, quantitative evaluation in advance of the quality of products, information, or services supplied by a supplier firm if there have been few or no past transactions with the supplier firm. As a result, the selected firm may not necessarily be able to provide high-quality products, information, or services, thus preventing the purchase of high-quality products, information, or services. The supplier firm is not able to indicate to the purchasing firm the level of quality that it supplies, thus making it difficult for the level of quality to be reflected in the transaction price.

Also, in the conventional transaction between firms described above, it is difficult to obtain objective, quantitative evaluation in advance of the supplier firm's level of capability in achieving quality if there have been few or no past transactions with the supplier firm. As a result, the selected firm may not necessarily be able to provide high-quality products, information, or services, thus preventing the purchase of high-quality products, information, or services. The supplier firm is not able to indicate to the purchasing firm its level of capability in achieving quality, thus making it difficult for the level of quality to be reflected in the transaction price.

As a result, the purchasing firm cannot efficiently obtain high-quality products, information, or services, leading to cost increases, shipment delays, or low-quality final products. In global purchasing, the majority of negotiations take place with firms with which no past transactions have been made. Thus, there is a need for a system that can provide efficient purchasing of high-quality products, information, or services.

Regarding the quality system standards of the conventional technology described above, there are currently many firms that have received certification for these quality system standards. Thus, “certification in a quality system standard” does not by itself serve as useful information when selecting a supplier out of multiple suppliers. Thus, this information is inadequate for making purchasing decisions.

Also, the evaluation scores reported in the quality system inspection results from the conventional technology described above can serve as material for selecting a supplier out of multiple supplier firms since it allows comparisons of multiple firms to be made. However, this information is inadequate for making purchasing decisions since determining specific failure rates (product defect rates) in the products supplied by the firm based on the evaluation scores of the conventional technology is difficult.

A client that purchases a product desires that the purchased product can be used with no problems under the client's usage conditions or that a product satisfying the product specifications requested by the client to the supplier firm can be supplied in a stable manner. Thus, ideally the purchaser should be able to quantitatively assess potential product defects, how low the risk associated with the delivered products (the expected fault modes and the product of seriousness and frequency) is, and the like. Then, the purchaser could decide on a supplier by taking into account the product purchasing fees and the losses that will be incurred due to defects. To do this, the defect potential of the delivered product or the level of capability of the supplier firm in achieving quality in the supplied product must be known quantitatively beforehand.

### SUMMARY OF THE INVENTION

The present invention seeks to overcome the problems of the conventional technology described above.

A first object of the present invention is to promote smooth purchasing of products in the following manner: An index (measure) is introduced to indicate the quality level of a product or information or service provided by a firm or the capability level of the supplier firm for achieving quality in a supplied product. The purchasing firm uses this quality level index in the supplier solicitation conditions when soliciting supplier firms.

A second object of the present invention is to promote smooth purchasing of products in the following manner: An index (measure) is introduced to indicate the quality level of a product or information or service provided by a firm or the capability level of the supplier firm for achieving quality in a supplied product. The supplier firm is able to decide whether or not to respond to a solicitation by comparing the quality level index in the supplier solicitation condition indicated by the purchasing firm with the quality level index for the product or information or service that it produces or its own capability level index relating to achieving quality. If the supplier firm responds to the solicitation, it provides the transaction mediator or the purchasing firm with its own product quality level in the form of the quality level index.

A third object of the present invention is to provide an inter-firm transaction mediation method that allows efficient selection of a supplier with a high quality level in the following manner: The transaction mediator compares the quality level index of a supplier firm responding to the solicitation with the requested quality level index in the supplier solicitation conditions of the purchasing firm. If multiple supplier firms respond, the quality level indices of the supplier firms are compared.

A third object of the present invention is to provide transparency in transactions in the following manner: The purchasing firm compares the estimate information received from the supplier firms. The results are sent to the bidding firms through a network., and the evaluation results of the bidding firms are posted on the purchasing firm's web site, disclosing quality evaluation details, standards, and bidding results (quality evaluation results), thus indicating that the quality evaluation was fair.

In order to achieve the objects described above, an inter-firm transaction mediation method according to the present invention sets up an inter-firm transaction mediation site on the Internet to mediate transactions between firms. This site is equipped with functions that allow negotiations to be carried out efficiently based on the quality level of the product involved in the transaction or the quality level of the production plant of the firm supplying the product. Furthermore, this inter-firm transaction mediation site provides by way of the network a quality calculation program to firms desiring inter-firm transactions. The quality calculation program provides an estimated evaluation of product quality by evaluating product quality separately in terms of “product specifications” and “production plant conditions,” and then combining the two evaluation results. As a result, the following indices can be calculated by the firms desiring inter-firm transactions and can be used as requested conditions for transactions:

an index indicating quality of the product or service involved in the transaction (estimated defect rate)

an index indicating the level of capability in achieving quality for the product or service involved in the transaction (plant constant)

an index indicating the level of difficulty involved in achieving high quality for the product or service involved in the transaction (product structure coefficient).

By providing the quality calculation program, the following aspects can be introduced to transactions between firms:

a measure indicating quality of products and services involved in transactions

a measure indicating the level of capability in achieving quality for products or services involved in transactions

a measure indicating the level of difficulty involved in achieving high quality for products or services involved in transactions

The purchasing firm uses the quality calculation program obtained from the inter-firm transaction mediation site to enter information about the product to be purchased and to calculate an index (product structure coefficient) indicating the degree of difficulty involved in producing the product to be purchased. Also, a production quality level index (plant constant) required for a supplier firm to be able to provide a quality level (defect rate coefficient) requested by the purchasing firm for the product to be purchased is calculated from the quality level (defect rate coefficient) requested by the purchasing firm for the product to be purchased and the index (product structure coefficient) indicating the degree of difficulty involved in producing the product to be purchased. Then, the quality level (defect rate coefficient) requested by the purchasing firm for the product to be purchased and the production quality level index (plant constant) that the supplier firm needs to have to achieve the quality level (defect rate coefficient) requested by the purchasing firm for the product to be purchased are sent by the purchasing firm as requested transaction conditions to the inter-firm transaction mediation site by way of the network.

The supplier firm uses the quality calculation program obtained from the interfirm transaction mediation site to enter production plant conditions information for the supplier firm and to calculate an index (plant constant) indicating the production quality level of the production plant. This calculated production quality level information for the production plant can be sent as requested transaction information to the inter-firm transaction mediation site by the supplier firm by way of the network. Alternatively, the quality calculation program obtained from the inter-firm transaction mediation site can be used to enter design information about the product produced by the production plant and to calculate an index (product structure coefficient) indicating the degree of difficulty of producing the product to be involved in the transaction. Then, the production plant conditions information of the supplier firm is entered, and an index plant constant) indicating the production quality level of the firm is calculated. These two calculated indicates are used to calculate an index (defect rate coefficient) indicating the quality of the product produced by the supplier firm. This calculated index (defect rate coefficient) indicating the quality of the product produced by the supplier firm is sent as a requested transaction condition to the inter-firm transaction mediation site by way of the network.

The inter-firm transaction mediation site receives requested transaction condition information from the purchasing firm and the supplier firm. More specifically, a requested quality level (defect rate coefficient) for the product to be involved in the transaction and a requested production quality level (plant constant) of the supplier firm are posted by the purchasing firm to the inter-firm transaction mediation site as conditions. The supplier firm posts to the inter-firm transaction mediation site the index (defect rate coefficient) indicating quality of the product to be involved in the transaction as supplied by the supplier firm and the index (plant constant) indicating the production quality level of the supplier firm.

The inter-firm transaction mediation site compares the quality level (defect rate coefficient) of the product to be involved in the transaction and the supplier firm production quality level (plant constant) posted by the purchasing firm with the quality level (defect rate coefficient) of the product to be involved in the transaction and the supplier firm production quality level (plant constant) posted by the supplier firm. A supplier firm satisfying the conditions posted by the purchasing firm is selected as a candidate supplier firm, and the purchasing firm and the supplier firm are contacted.

In the description above, the firms requesting a transaction calculate quality indices themselves, but it would also be possible to have the inter-firm transaction mediator receive the information needed for quality calculations from these firms and calculate quality levels from the received information.

This allows the purchasing firm to easily negotiate with a supplier firm having a desired quality level. Also, the supplier firm is able to easily negotiate by responding to purchasing solicitations that match its own quality levels. Also, since the negotiation partners can be selected based on the indices described above, negotiations can be started quickly, thus allowing high-quality products to be purchased quickly.

According to the method of the present invention, purchasing manufacturers can purchase high-quality items efficiently. Also, supplier manufacturers are provided with information about quality needed for a transaction, so transactions can be selected based on their own quality levels. This establishes quality targets for transactions and increases motivation to improve quality, thereby improving quality for the industry as a whole.

### BRIEF DESCRIPTION OF THE DRAWINGS

FIG. 1 is a drawing illustrating the idea behind the quality calculation method of the present invention.

FIG. 2 is a drawing showing the architecture of an embodiment of a system according to the present invention.

FIG. 3 is a drawing showing the architecture of an embodiment of a system according to the present invention.

FIG. 4 is a drawing showing an example of a flow of operations in an inter-firm transaction method according to the method of the present invention.

FIG. 5 is a drawing showing the idea behind the quality calculation method of the present invention.

FIG. 6 is a drawing showing the idea behind the quality calculation method of the present invention.

FIG. 7 is a drawing showing the architecture of a system in which a quality calculation program according to the present invention is installed.

FIG. 8 is a drawing showing an example of a database that uses a quality calculation program according to the present invention.

FIG. 9 is a drawing showing the architecture of a system in which a quality calculation program according to the present invention is installed.

FIG. 10 is a drawing showing an example of a flow of operations in a quality calculation program according to the present invention.

FIG. 11 is a drawing showing an example of an input screen of a quality calculation program according to the present invention.

FIG. 12 is a drawing showing an example of an input screen of a quality calculation program according to the present invention.

FIG. 13 is a drawing showing an example of a flow of operations in a quality calculation program according to the present invention.

FIG. 14 is a drawing showing an example of an output screen of a system according to the present invention.

FIG. 15 is a drawing showing an example of an output screen of a system according to the present invention.

FIG. 16 is a drawing illustrating the idea behind a quality calculation method according to the present invention.

FIG. 17 is a drawing showing the architecture of a system in which a quality calculation method according to the present invention is installed.

FIG. 18 is a drawing showing an example of an input screen in a system according to the present invention.

FIG. 19 is a drawing showing an example of an input screen in a system according to the present invention.

FIG. 20 is a drawing showing an example of a flow of operations in an inter-firm transaction method according to a method of the present invention.

FIG. 21 is a drawing showing an example of a flow of operations in an inter-firm transaction method according to a method of the present invention.

FIG. 22 is a drawing showing an example of a flow of operations in an inter-firm transaction method according to a method of the present invention.

FIG. 23 is a drawing showing an example of the flow of web pages in an inter-firm transaction method according to the present invention.

FIG. 24 is a drawing showing an example of a homepage in a transaction mediation sit e according to the present invention.

FIG. 25 is a drawing showing an example of a member's homepage in a transaction mediation site according to the present invention.

FIG. 26 is a drawing showing an example of a purchase request registration screen according to the present invention.

FIG. 27 is a drawing showing an example of a supplier supply request registration screen according to the present invention.

FIG. 28 is a drawing showing an example of a purchase solicitation display selection screen.

FIG. 29 is a drawing showing an example of a list of purchase solicitations according to the present invention.

FIG. 30 is a drawing showing an example of a purchase request solicitation display selection screen according to the present invention.

FIG. 31 is a drawing showing an example of search results for supply request solicitations by a supplier for a general-purpose product.

FIG. 32 is a drawing showing an example of a supplier firm's search results for supply requests for a custom product according to the present invention.

FIG. 33 is a drawing showing an example of a quality calculation method help screen according to an embodiment of the present invention.

FIG. 34 is a drawing showing an example of a display screen of solicitation matching operation results from a transaction method according to the present invention.

FIG. 35 is a drawing showing an example of transaction solicitation information sent to a purchasing firm according to the present invention.

FIG. 36 is a drawing showing a flow of operations in another embodiment of the present invention.

FIG. 37 is a drawing showing the give and take of information in another embodiment of the present invention.

FIG. 38 is a drawing showing connections over a network in another embodiment of the present invention.

FIG. 39 is a drawing showing a hardware architecture of a quality estimation system according to another embodiment of the present invention.

FIG. 40 is a drawing showing the idea behind quality estimation calculations in another embodiment of the present invention.

FIG. 41 is a drawing showing an example of a display screen from a purchasing firm's web site according to another embodiment of the present invention.

### DESCRIPTION OF THE PREFERRED EMBODIMENTS

The present invention is further described in detail below, with references to the figures.

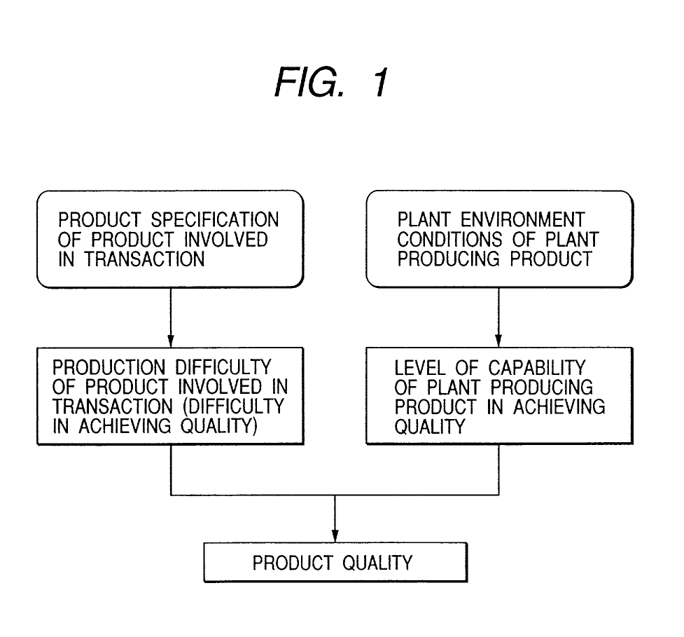

FIG. 1 shows the approach of the present invention for evaluating the manufacturing quality of product involved in a transaction using a quality calculation program, which implements the inter-firm transaction mediation of the present invention.

Our research has shown that the production quality of a product is determined by the difficulty of production (difficulty of achieving quality) of the product to be manufactured and by the capability for achieving quality of the plant that manufactures the product. In addition, this difficulty of production (difficulty of achieving quality) of the product is determined by the product specifications, and the capability for achieving quality of the plant is determined by the environmental conditions of the plant.

In other words, the difficulty of production (difficulty of achieving quality) of the product is evaluated from product specification information, and the capability for achieving quality of the plant is evaluated from the environmental conditions of the plant. From these evaluation results, the quality level of the product or the defect rate of the product can be predicted.

Applying this, a method for mediating inter-firm transactions that implements supplier selection using the quality level of the item involved in the transaction will be described.

A first embodiment of the method for mediating transactions between firms according to the present invention will be described below.

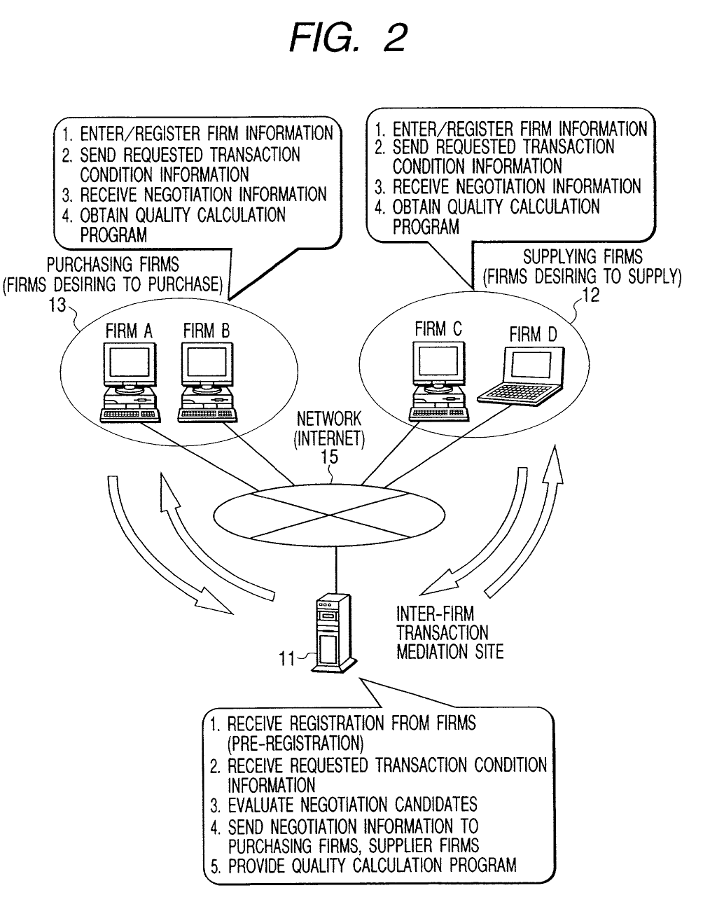

FIG. 2 shows a schematic drawing of the method for mediating transactions between firms according to the present invention.

In the present invention, an inter-firm transaction mediation web site 11, which mediates transactions between firms, is provided on the Internet, and it can send and receive information with firms that wish to conduct inter-firm transactions. Firms that wish to conduct inter-firm transactions can be classified as purchasing firms wishing to purchase products or information or services and supplier firms wishing to supply products or information or services. Each of the firms wishing to conduct these inter-firm transactions connect to the inter-firm transaction mediation web site 11 through an Internet 15, and they can send information relating to the requested conditions for the transaction to the inter-firm transaction mediation web site 11. In addition, they can receive negotiation information from the inter-firm transaction mediation web site 11.

In other words, as shown in FIG. 2, the system of the present invention that conducts mediation for inter-firm transactions of products or information or services using a network includes: the inter-firm transaction mediation web site 11 that accepts through the network from firms that wish to purchase products or information or services (purchasing firms) information about the products or information or services that the purchasing firms wish to purchase, and also accepts through the network from firms that wish to supply the products or information or services (supplier firms) information about the supplier firms, and based on all of the information that is received, selects negotiation candidates, and sends the selected negotiation candidate information through the network to the purchasing firm and the supplier firm that are party to the negotiation; and a wide-area information searching system (WWW (World Wide Web)) that is connected through an Internet connection computer terminal 12 of the purchasing firm and an Internet connection computer terminal 13 of the supplier firm by the Internet 15. This wide area information searching system constructs hypertext on the network 15 (the Internet, in particular), and all kinds of information can be accessed. Therefore, the inter-firm transaction mediation web site (inter-firm transaction mediation system) 11 of the present invention is made available on the Internet 15.

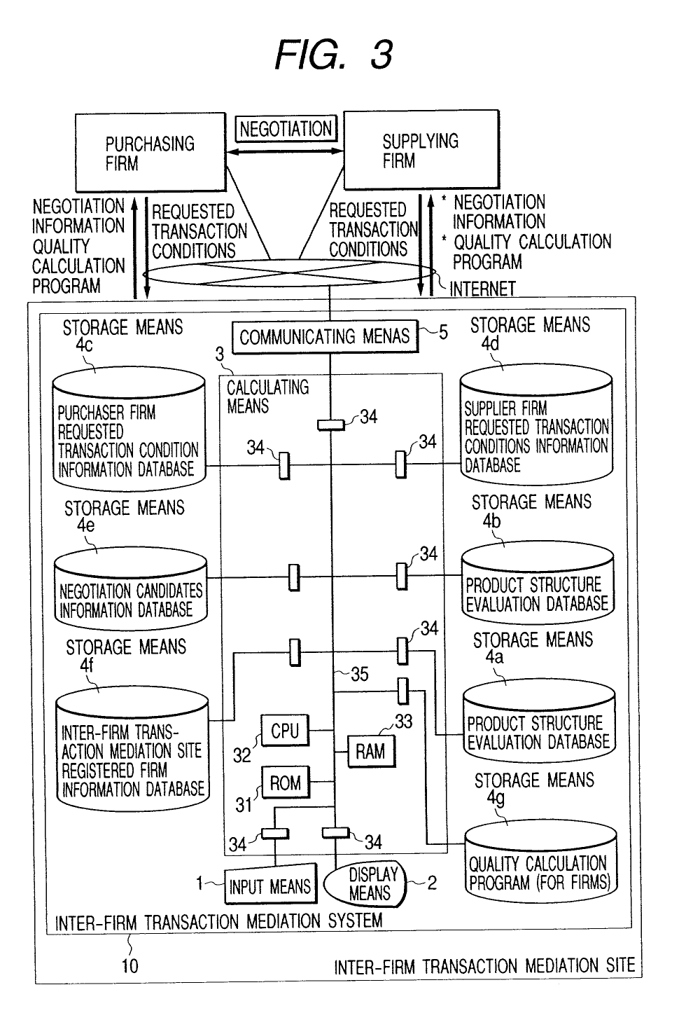

The inter-firm transaction mediation web site 11 includes an inter-firm transaction mediation system 10. FIG. 3 shows the details of the inter-firm transaction mediation system 10 of the present invention.

As shown in FIG. 3, the inter-firm transaction mediation system 10 includes: input means 1 such as keyboard, mouse, pen input tablet, and the like; output means 2 formed from output means such as display means or printing means, e.g., a display monitor or the like; calculating means 3 performing the transaction mediation operations of the present invention; storage means 4a, storage means 4b, storage means 4c, storage means 4d, storage means 4e, storage means 4f, and storage means 4g for storing received data of the results of quality evaluation, the results calculated by calculating means 3, a quality calculation program to be provided to the firms, and the like; communication means 5 for inputting and outputting information with another system through a network such as the Internet or the like. Calculating means 3 is constructed from a CPU 32, a ROM 31 for storing a predetermined program, a RAM 33 for temporary storage of various types of data, an input/output interface module 34, and a bus line 35, and the like.

The inter-firm transaction mediation system 10 connects a computer (calculating means) 3 to the Internet 15 through communication means 5 formed from a modem or the like. For firms that wish to conduct transactions, in order to provide programs for calculating quality (a “product structure evaluation calculation program” for predicting manufacturing quality of the transaction product and a “plant evaluation calculation program” for evaluating the capability for achieving quality for the supplied product of the plant of the supplier firm), and in order to collect and provide information on products or information or services that purchasing firms wish to purchase and information relating to supplier firms, a web page (a so-called home page) is made available. For this, quality calculation programs (the “product structure evaluation calculation program” for predicting manufacturing quality of the transaction product and the “plant evaluation calculation program” for evaluating the capability for achieving quality for the supplied product of the plant of the supplier firm), which are described in HTML (Hyper Text Markup Language) format and the like are stored in storage means 4g. In addition, storage means 4g stores information on text and images that are to be displayed on the web page screen for collecting and providing information relating to products or information or services that the purchasing firms wish to purchase and information relating to the supplier firms. Storage means 4g also stores information on the placement of these text and images.

When this information is viewed by a browser software connected to the Internet connection computer terminal 12 and the Internet connection computer terminal 13 of the purchasing firm and supplier firm, the web page can be displayed on the output screen.

More specifically, a storage device connected to computer 3 of the inter-firm transaction mediation web site 11 contains the following: a database 4a for storing coefficients and constants and the like used in the plant evaluation calculation program (or its evaluation), which evaluates the capability for achieving quality for the supplied product of the plant of the supplier firm; a database 4b for storing coefficients and constants and the like used in the product structure evaluation calculation program and its evaluation, which predicts the manufacturing quality of the transaction product; a purchasing firm requested transaction conditions information database 4c for storing information that is received from the purchasing firm and relates to the products or information or services that the purchasing firm wishes to purchase; a supplier firm's requested transaction conditions information database 4d for storing the supplier firm requested transaction conditions information that is received from the supplier firm; a negotiation candidate information database 4e for storing information of the negotiation candidate selected by the inter-firm transaction mediation web site (inter-firm transaction mediation system) 11; a site registered firms database 4f for storing registration information such as names or ID codes for purchasing firms or supplier firms that wish to have transactions mediated by the inter-firm transaction mediation web site; and a quality calculation program database 4g for storing quality calculation programs that are provided to the firms.

In the description above, information received from the purchasing firm and relating to products or information or services that the purchasing firm wishes to purchase includes information such as specification information relating to the requested products or information or services, requested purchase price, requested purchase quantity, requested delivery date, requested purchase quality, and the capability, requested by the purchasing firms, relating to achieving quality for the supplied product of the supplier firm.

Furthermore, information received from the supplier firm and relating to the supplier firm includes information such as list of available products, and information relating to the supply capacity of the supplier firm, and the like. Furthermore, the information of the supply capacity of the supplier firm is information such as the quantity that can be supplied by the supplier firm in a set period of time, the capability for achieving quality for the supplied product, and the like.

In addition, by connecting to the Internet 15 through the Internet connection computer terminal 12 and the Internet connection computer terminal 13, the firms can connect to the inter-firm transaction mediation web site (inter-firm transaction mediation system) 11 of the present invention. From there, quality calculation programs (“product structure evaluation calculation program” for predicting manufacturing quality of the transaction product and “plant evaluation calculation program” for evaluating the capability for achieving quality for the supplied product of the plant of the supplier firm) can be obtained by downloading, or information relating to the requested products or information or services from the purchasing firms which are registered on the inter-firm transaction mediation web site can be viewed, or information relating to the registered purchasing firms and supplier firms can be viewed, or negotiation information can be received, or conversely, information on the requested transaction conditions can be sent to the web site.

Furthermore, similarly, they can connect to a web site on which the evaluation method is posted (not shown) through the Internet connection computer terminal 13. From there, information on the evaluation methods which are made available for evaluating the quality of the products or information or services and the quality of the firms that provide these can be obtained, and evaluation programs can be obtained.

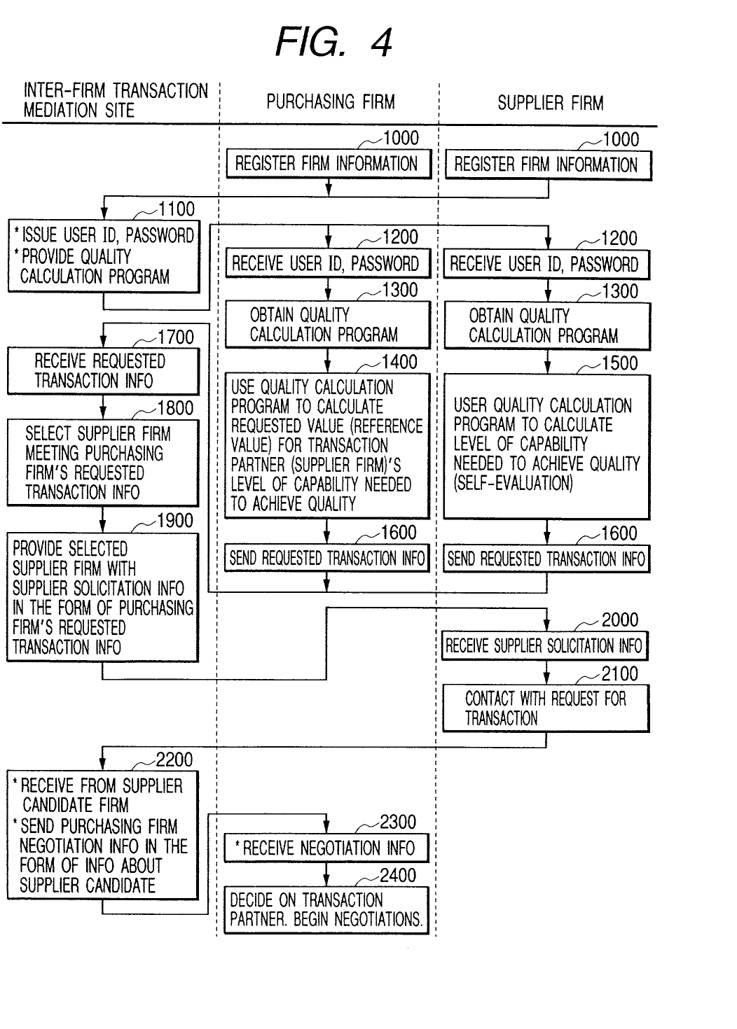

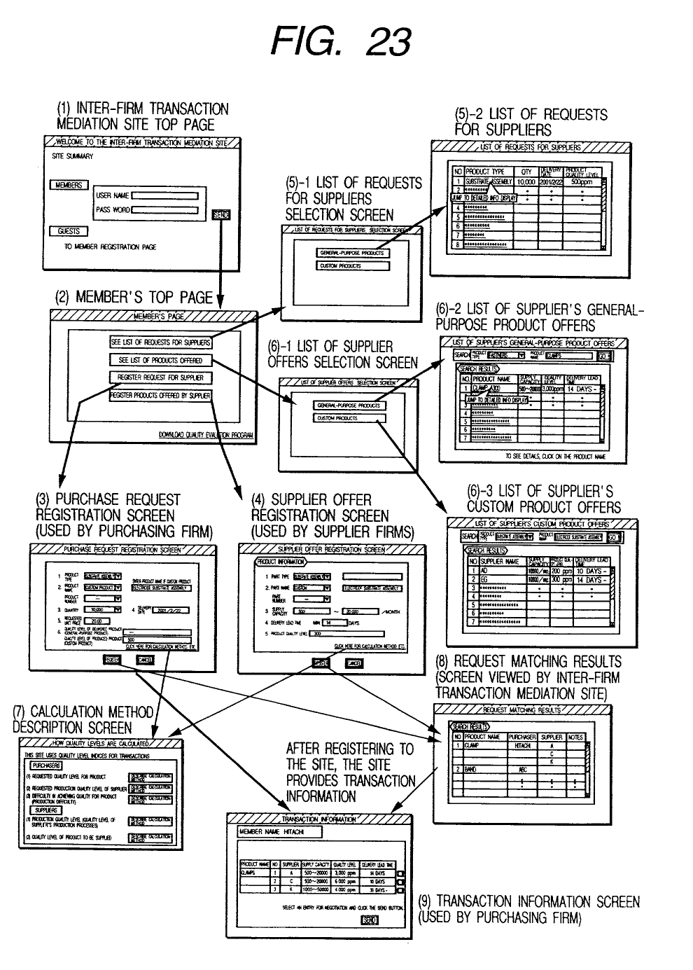

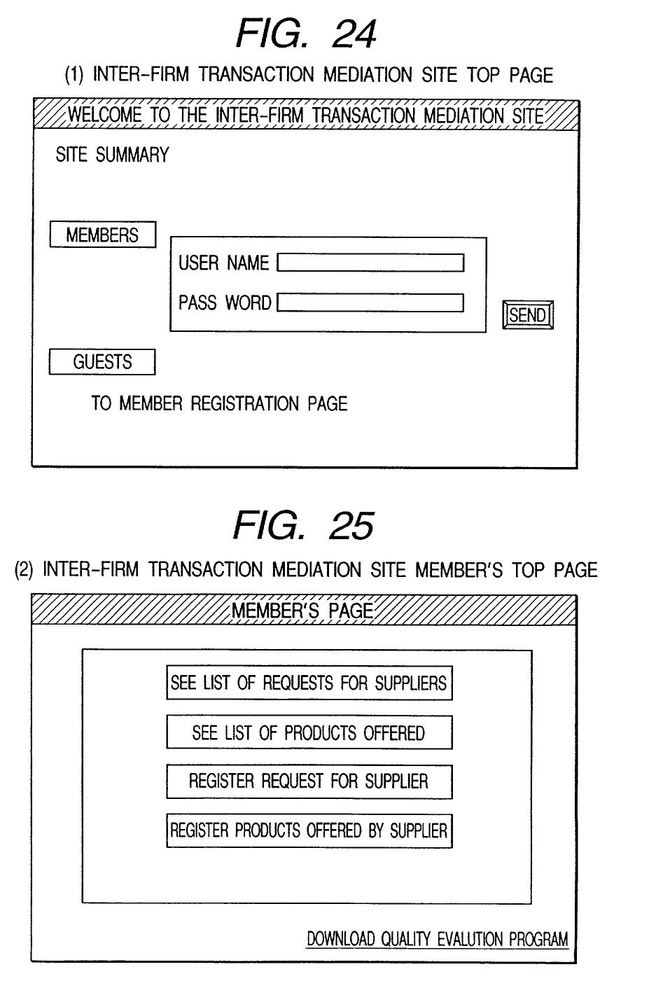

FIG. 4 shows one example of the flow of operations up to the inter-firm transaction mediation by the method of the present invention. There will be a description below for each step of FIG. 4. Furthermore, FIG. 23 shows the flow of screens on the web in an embodiment of the present invention. FIG. 24-FIG. 35 show details for each of these screens. These screens are displayed on the display device on the terminal device 12 of the purchasing firm, on the terminal device 13 of the supplier firm, or on the terminal device of the inter-firm transaction mediation agent.

(Step 1000)

Step whereby purchasing firm and supplier firm participating for the first time at the inter-firm transaction mediation web site 11 register firm information onto the interfirm transaction mediation web site from terminal device:

Purchasing firms and supplier firms participating for the first time at the interfirm transaction mediation web site 11 connect to the inter-firm transaction mediation web site 11 using the Internet connection terminal 12 of the purchasing firm and the Internet connection terminal 13 of the supplier firm, and they register firm information.

An example of a method for registration is as follows. A registration page for the inter-firm transaction mediation web site is provided on the homepage of the inter-firm transaction mediation web site 11. A firm that wishes to participate in the inter-firm transaction mediation web site inputs the information of the firm required for registering at the inter-firm transaction mediation web site. By sending the information to the interfirm transaction mediation web site, the firm is registered as a participating firm in the inter-firm transaction mediation web site. A firm that wishes to participate in the interfirm transaction mediation web site can access this web page and register. The following is an example of another registration method. A firm that wishes to participate in the interfirm transaction mediation web site sends, by electronic mail to the inter-firm transaction mediation web site, information required for registering at the inter-firm transaction web site. The inter-firm transaction mediation web site, which has received this information, conducts registration operations, and registration is performed.

(Step 1100)

A user ID and password are issued from the inter-firm transaction mediation web site, and quality calculation programs are provided:

The inter-firm transaction mediation web site 11 issues a user ID and password to a firm that has registered firm information in Step 1000. This, together with the registration information received from the firm, is stored in the inter-firm transaction mediation site's registered firms information database 4f which is provided in the interfirm transaction mediation system 10 of the inter-firm transaction mediation web site 11. Information on the user ID and password is provided through the network to the firm that has registered firm information. Examples of providing methods include a method for providing using electronic mail and a method for providing on the screen of the inter-firm transaction mediation web site. With either method, the purchasing firm or the supplier firm that has registered can become a member of the inter-firm transaction.

Furthermore, the inter-firm transaction mediation web site 11 provides quality calculation programs through the network to firms that have registered firm information in step 1000. The quality calculation programs that are provided are the “product structure evaluation calculation program” for predicting manufacturing quality of the transaction product and the “plant evaluation calculation program” for evaluating the capability for achieving quality for the supplied product of the plant of the supplier firm. These are stored in the database 4g provided on the inter-firm transaction mediation system 10 of the inter-firm transaction mediation web site 11.

For the method of providing the quality calculation programs, there is a method wherein: a download button for the quality calculation programs is provided on the screen of the web page of the inter-firm transaction mediation web site; a firm that wishes to use the quality calculation programs connects to the web page of the inter-firm transaction mediation web site and pushes the download button (clicks with a mouse) for the quality calculation programs; and by doing so, the quality calculation programs are sent to the computer serving as the connection terminal of the firm that wishes to use the quality calculation programs. In this case, the quality calculation programs are installed and used in the computer of the firm.

In addition, as another method for providing the quality calculation program, there is a method whereby the quality calculation programs can be used at the web page of the inter-firm transaction mediation web site. In this case, when a member firm wishes to use the quality calculation programs, the member firm connects to the web page of the inter-firm transaction mediation web site each time. By inputting the information needed for the calculation at the web page and sending the information to the inter-firm transaction mediation web site, based on the entered information, the quality calculation is conducted by the quality calculation programs stored in the inter-firm transaction mediation system of the inter-firm transaction mediation web site. The calculated results are displayed on the web page of the inter-firm transaction mediation web site. This is a method for providing the quality calculation programs with the inter-firm transaction mediation web site as the ASP (application service provider).

(Step 1200)

A firm that has registered at the inter-firm transaction mediation web site receives user ID and password information:

A firm that has registered firm information receives from the inter-firm transaction mediation web site information on user ID and password for participating in the inter-firm transaction mediation web site. Using these, the firm can access this web site, and as a member, the firm can receive the transaction mediation services.

(Step 1300)

A firm registered at the inter-firm transaction mediation web site obtains the privilege to access quality calculation programs:

As described in step 1100 above, one way for a firm registered on the inter-firm transaction mediation web site to obtains access privileges for the quality calculation programs is to have the quality calculation programs downloaded from the inter-firm transaction mediation web site so that they can be used. Another method is to allow the quality calculation programs to be used from a web page of the inter-firm transaction mediation web site.

Access privileges include the privilege to use the quality calculation programs provided by the ASP. This can be a restricted access privilege with restrictions on the access time and limited to the transaction product types and product items as described later.

(Step 1400)

A step whereby a purchasing firm calculates a requested value (standard value) for the capability for achieving quality of the transaction client (supplier firm) using the quality calculation programs:

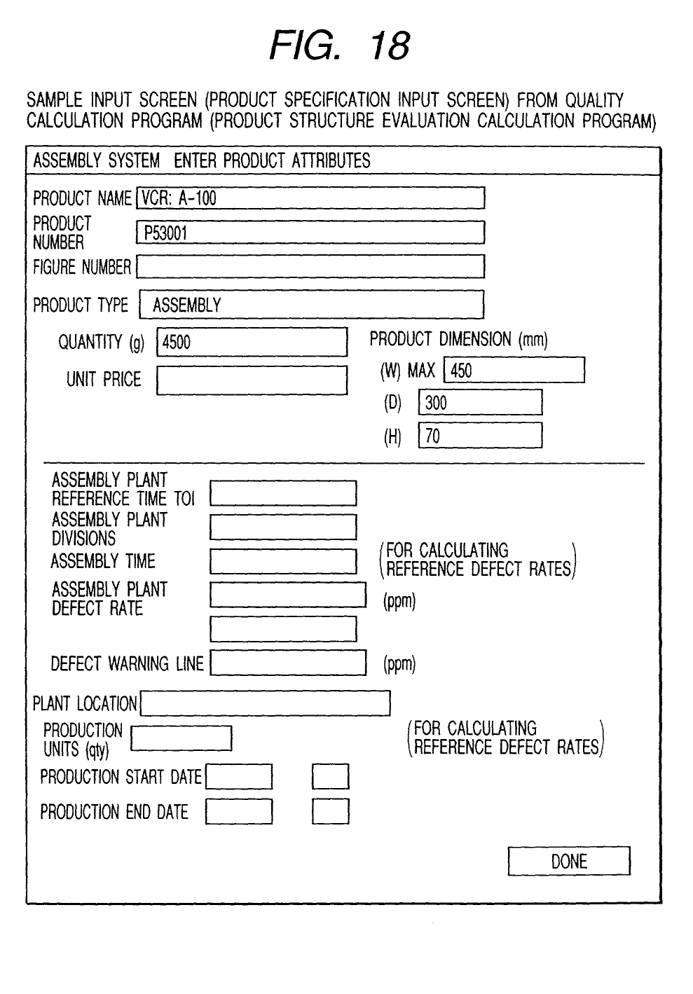

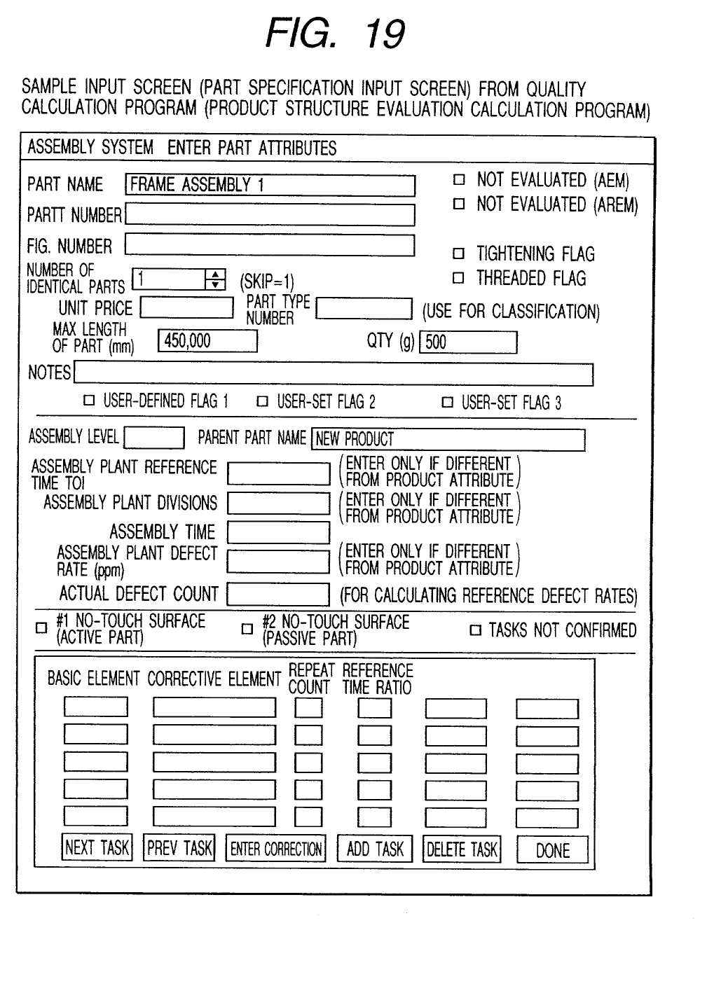

Using the “product structure evaluation calculation program” to which the purchasing firm has obtained access and which is for predicting manufacturing quality of the transaction product, the purchasing firm inputs information relating to the specifications of the requested purchase product and information on the requested quality (FIG. 18 and FIG. 19 show examples of the input screen). An index for the capability for achieving quality for the supplied product that the supplier firm should have in order to supply a product of a quality level requested by the purchasing firm is calculated. Details of the “product structure evaluation calculation program” are described later.

(Step 1500)

A step whereby a supplier firm calculates its own capability for achieving quality using the quality calculation programs (self-evaluation):

Using the “plant evaluation calculation program” for which the supplier firm has obtained access and which is used to evaluating the capability for achieving quality for the supplied product of the plant of the supplier firm, the plant environmental conditions of the production plant of the supplied product of the supplier firm are entered (FIG. 12 shows an example of an input screen). An index for the capability for achieving quality for the supplied product of the production plant of the supplied product of the supplier firm is calculated. Details of the “plant evaluation calculation program” are described in detail later.

(Step 1600)

A step whereby a purchasing firm and a supplier firm send requested transaction conditions to the inter-firm transaction mediation web site:

The purchasing firm sends to the inter-firm transaction mediation site 11 information on the index for the capability for achieving quality for the supplied product that a supplier firm that wishes to conduct a transaction should have. This index is calculated in step 1400, and this information is sent to the inter-firm transaction mediation site 11 as one of the conditions regarding the requested purchase product.

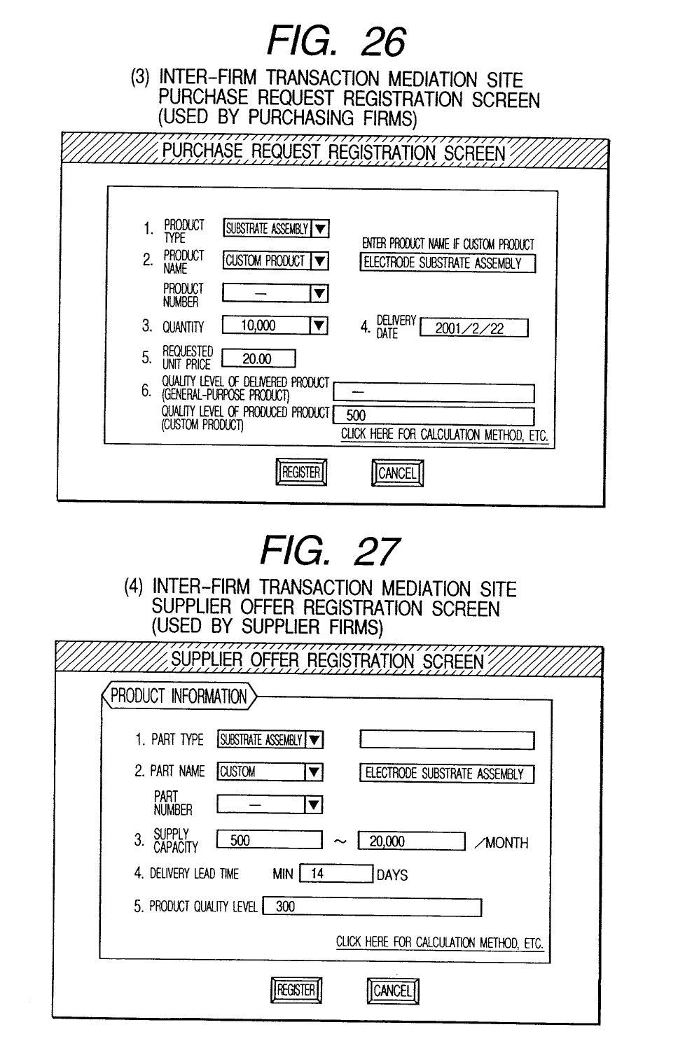

First, at the input screen on the Web shown in FIG. 24, the purchasing firm connects to the inter-firm transaction mediation site 11 using the user name and password obtained earlier (FIG. 23 (1)). At the members' homepage shown in FIG. 25, “To requested purchase registration” (FIG. 23 (2)) is selected, and the screen shifts to the requested purchase registration screen shown in FIG. 26.

FIG. 26 shows an example of a purchasing firm wishing to purchase a custom product. At the computer terminal of the purchasing firm, the product type of the custom product, “substrate assembly,” and the product name, “custom product,” are selected from pull down menus. For the specific product name, “electrode substrate assembly” is separately entered. In this embodiment, in addition to the input information above, information relating to the goods and the like that the purchasing firm wishes to purchase, such as requested purchase quantity, requested delivery date, requested purchase price, and manufacturing quality level which is the requested quality level calculated and outputted earlier (Step 1400) (the index value of the plant quality level of the supplier) are entered. When the purchasing product is a general-purpose product, the supplied product quality level (index value of the quality level of the object) is entered as the requested quality level.

In conventional electronic business transactions, specific standard values for product quality could not be found in the “plant environment” or “supplied product” of the supplier firms. However, with this embodiment, specific standard values can be obtained from the supplier firms. As a result, the supplier firms can be narrowed down or selected upon taking into consideration the specific standard values for product quality. Here, “substrate assembly” is treated as a category of a custom product. For the category of a general-purpose product (product type: fastener and the like), the product number can be entered as well.

The supplier firm sends to the inter-firm transaction mediation site 11 information on the index for the capability for achieving quality for the product from the plant producing the supplied product of the supplier firm. This index is calculated in step 1500, and this information is one item of information relating to the supplier firm.

First, as with the case of the purchasing firm described above, the supplier firm connects to the inter-firm transaction mediation site 11 using a user name and password. Next, at the member's home page shown in FIG. 25, “To requested supply registration for suppliers” (FIG. 23 (2)) is selected, and the screen shifts to a requested supply registration for suppliers screen shown in FIG. 27.

FIG. 27 shows a case where the supplier firm (supplier) wishes to supply a custom product of product type “electrode substrate assembly” of product type “substrate assembly”. Here, the information entered by the supplier firm (information relating to the supplier firm) is the supply capacity value or supply capacity range, delivery lead time, and the capability for achieving quality for the supplier firm (supplied product quality level) as calculated and outputted earlier (step 1500). However, entering other information such as requested supply price and the like is within the scope of the present invention.

In this manner, for a product type and product item, the quality capability of a supplier firm can have a specific value and can be a condition for the transaction. As a result, for supplier firms with high quality capability, an objective standard for the quality capability can be used as a selling tool.

(Step 1700)

A step whereby the inter-firm transaction mediation web site receives the requested transaction conditions from a purchasing firm and a supplier firm:

From the purchasing firm, for the requested transaction condition, the inter-firm transaction mediation web site 11 receives information on the conditions relating to the products that the purchasing firm wishes to purchase. This information includes information of the index for the capability for achieving quality for the supplied product that the supplier firm that desires the transaction should have. This information is stored in the purchasing firm's requested transaction conditions information database 4c provided in the inter-firm transaction mediation system 10 of the inter-firm transaction mediation web site.

From the supplier firm, for the requested transaction condition, the inter-firm transaction mediation web site 11 receives information relating to the supplier firm. This information includes information on the index of the capability for achieving quality for a supplied product of a production plant for the supplied product of this supplier firm. This information is stored in the supplier firm's requested transaction conditions information database 4d provided on the inter-firm transaction mediation system 10 of the inter-firm transaction mediation web site.

By clicking on the registration button of FIG. 26 or FIG. 27 with a mouse and the like, these operations are sent from,the terminal device of the purchasing firm or supplier firm through the network, and they are registered in the database 4c or the database 4d.

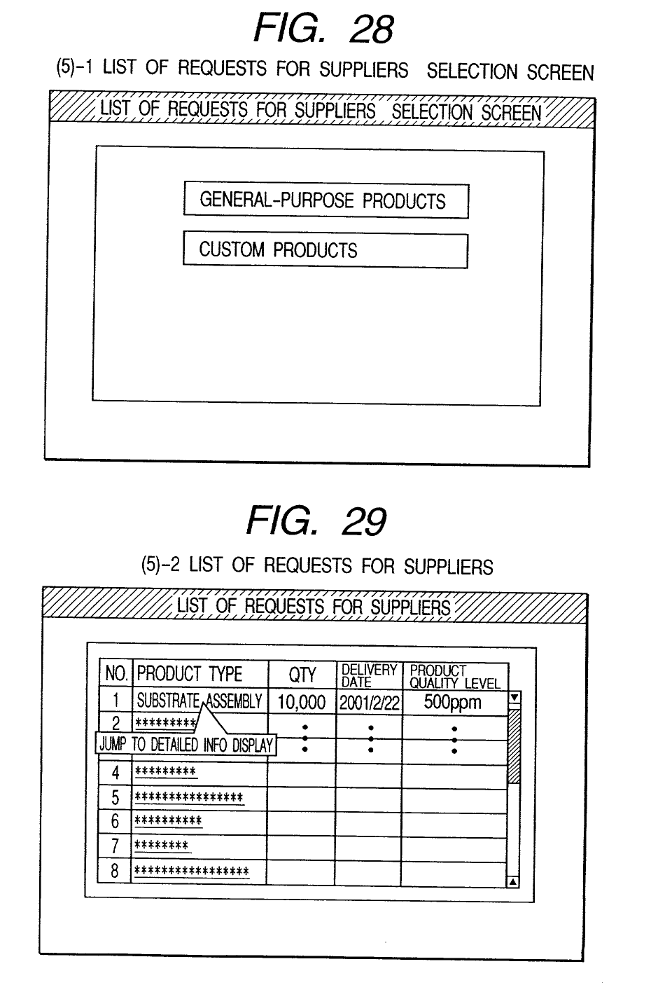

FIG. 28 through FIG. 32 show examples of displays in display means of the interfirm transaction mediation web site 11.

FIG. 28 and FIG. 29 show a list of information that the purchasing firm has entered and sent and that relates to the goods and the like that the purchasing firm wishes to purchase. It shows that information relating to product type “Substrate assembly” that has been sent earlier through the network from the terminal of the purchasing firm has been registered in list No. 1.

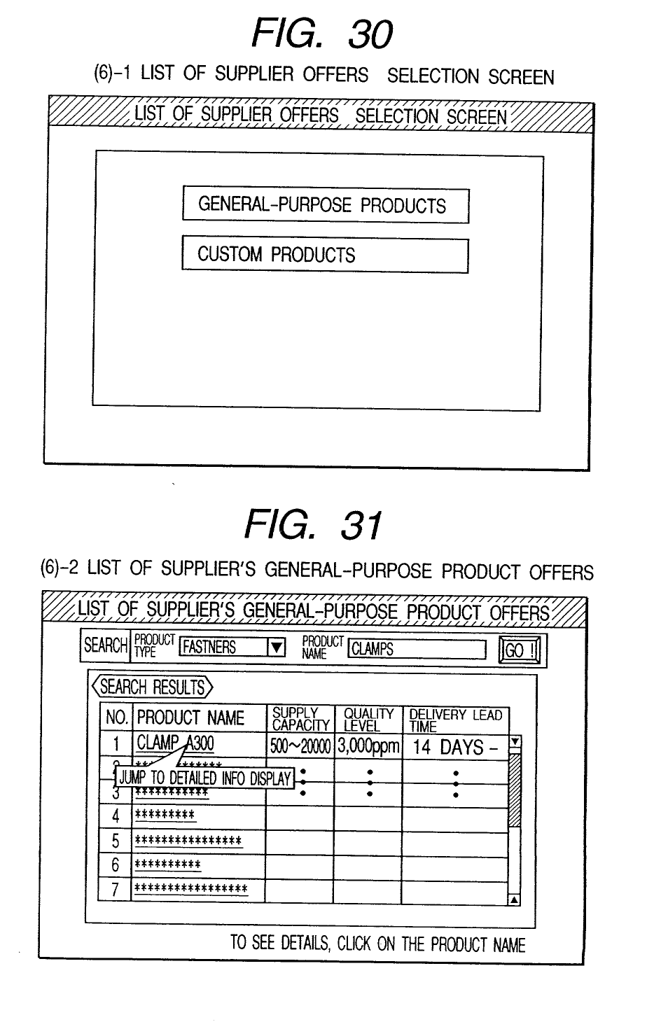

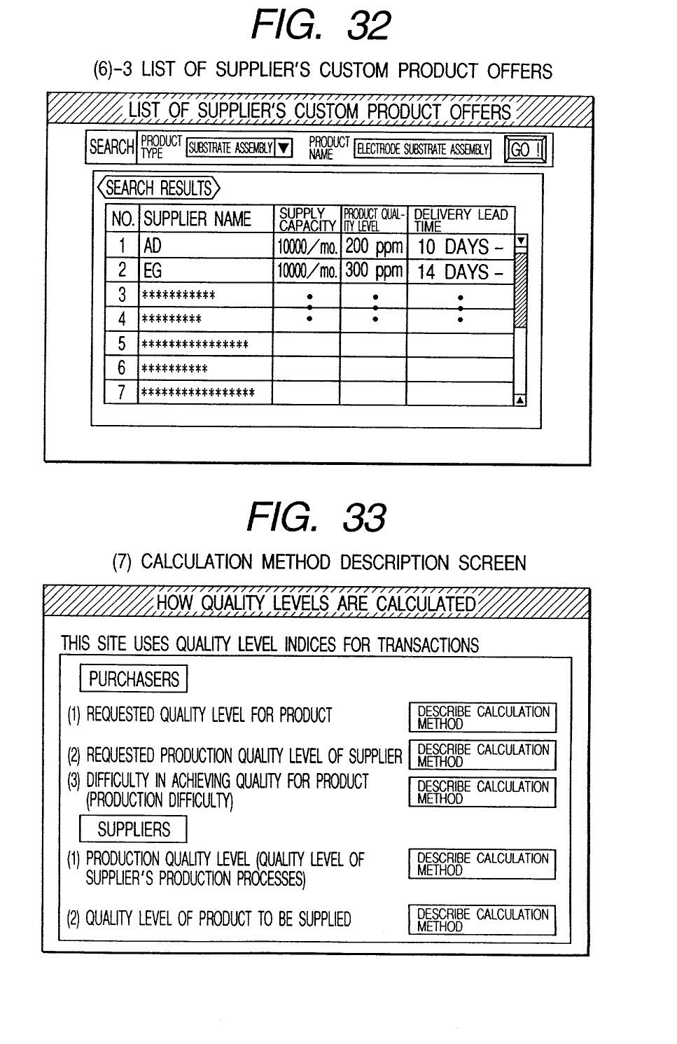

Furthermore, FIG. 30 through FIG. 32 show lists of the information that the supplier firm has entered and sent and that relates to the goods and the like that the supplier firm wishes to supply. They show lists that are seen under the category of general-purpose products and the lists that are seen under the category of custom products (FIG. 23 (6)-1-3). FIG. 31 shows, with search criteria of product type “fastener” and product name “clamp”, an example of a display screen in which product items such as clamp A300 and the like have been extracted. In addition, FIG. 32 shows the result of conducting a search process by product type “Substrate assembly” and product item “electrode substrate assembly.” On the sample display screen, suppliers for “electrode substrate assembly” under “substrate assembly” such as firm AD, firm EG and the like have been extracted. For the product type, other than these, searches for each type such as molded product, pressed products and the like can also be conducted.

In this embodiment, searches for product types and product items as described above can be conducted. However, not only can there be a situation where the searches are mainly conducted by the inter-firm transaction mediation site, but there can also be situations where the extraction operation from among the various supplied products is conducted by the purchasing firm itself using criteria for product type and product item that are requested for purchase.

(Step 1800)

Step whereby the inter-firm transaction mediation web site selects the supplier firm that satisfies the requested transaction conditions of the purchasing firm:

For selecting the negotiation candidate, the inter-firm transaction mediation system 10 of the inter-firm transaction mediation site 11 first selects from the supplier firm's requested transaction conditions information database 4c a conditions information that is received from a purchasing firm and that relates to the products or parts that are requested for purchase (henceforth referred to as supplier solicitation conditions information). This supplier solicitation conditions information that is selected and the information relating to a supplier firm that is received from the supplier firm and that is stored in the supplier firm's requested transaction conditions information database 4d are compared, and the supplier firm that satisfies the supplier solicitation conditions information described above is selected. More specifically, a supplier firm that satisfies the following conditions are selected.

Whether the supplier firm supplies the product type that the purchasing firm wishes to purchase.

Whether the supplier firm is capable of supplying the quantity that the purchasing firm wishes to purchase.

Whether the production plant of the supplier firm is capable of achieving quality for the supplied product that satisfies the standard requested by the purchasing firm.

For example, if the product that the purchasing firm wishes to purchase is a pressed sheet metal product, supplier firms that have specified pressed sheet metal product as a supplied product are selected from among the supplier firms. Or else, if the product that the purchasing firm wishes to purchase is an assembly product for an electronic device, supply firms that have specified assembly products for electronic devices as a supplied product are selected from among the supplier firms. In this manner, using product categories and product names, the supplier firms can be narrowed.

In the inter-firm transaction mediation method of the present invention, with the narrowing of the supplier firms with regard to the quality level, the index that represents the “standard value for the capability for achieving quality for the supplied product of the production plant of the supplier firm” that is requested by the purchasing firm as received from the purchasing firm and calculated by the purchasing firm using the “product structure evaluation calculation program” is compared with the “capability for achieving quality for the supplied product of the production plant of the supplied product” of the supplier firm as received from the supplier firm and calculated by the supplier firm using the “plant evaluation calculation program.” A supplier firm having the “capability for achieving quality for the supplied product of the production plant of the supplied product” that satisfies the “standard value for the capability for achieving quality for the supplied product of the production plant of the supplier firm” requested by the purchasing firm is selected.

The selection method is not limited to the above method. Methods which consider delivery conditions and cost conditions in addition to quality conditions are within the scope of the present invention. Furthermore, weighting coefficients depending on the priority of the quality, delivery, cost conditions can be assigned, and a total index value for the transaction condition can be calculated. Based on this value, selection can be conducted. These weighting coefficients can be assigned individually by the purchasing firm.

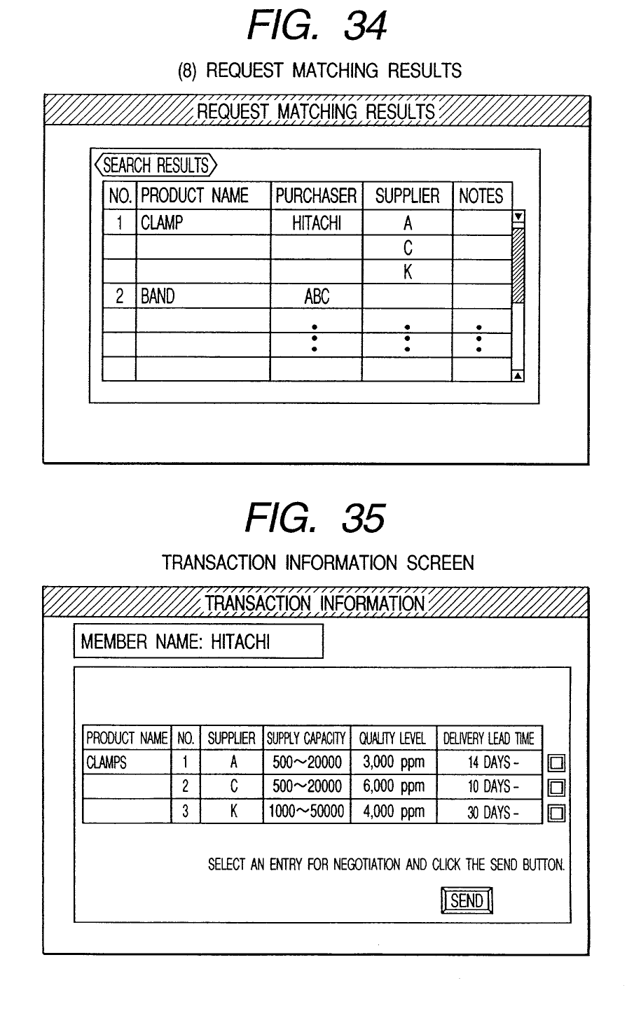

FIG. 34 shows one example of results of a selection (FIG. 23 (8)). FIG. 34 shows, with respect to a clamp, three companies of supplier firms (suppliers) A, C, K matched the supplier solicitation conditions for the purchasing firm “Hitachi.38 In some cases, this matching processing is conducted automatically by the inter-firm transaction mediation system 10 of the inter-firm transaction mediation site 11 based on information from purchasing firms and information from suppliers received within a set period. In other cases, selection (extraction) can be conducted mainly by the purchasing firm when the purchasing firm accesses the site for requested product types and product items.

In this manner, the inter-firm transaction mediation system 10 of the inter-firm transaction mediation system 11 selects supplier firms that satisfies the requested conditions of the purchasing firms.

Next, the information (ID information and the like) identifying the supplier firms that have been selected and the information specifying the supplier solicitation conditions information are stored together by the inter-firm transaction mediation system 10 in the negotiation candidate information database 4e provided in this system.

(Step 1900)

Step whereby the inter-firm transaction mediation site provides the selected supplier firm with the requested transaction conditions of the purchasing firm in the form of supplier solicitation conditions information:

From the negotiation candidate information database 4e, the inter-firm transaction mediation system 10 retrieves the information specifying the supplier firm selected by step 1800 and the information specifying the target supplier solicitation conditions information. Next, based on the retrieved information, the supplier firm that has been selected and the target supplier solicitation conditions information are specified. This specified solicitation conditions information is provided as the solicitation conditions information to the specified supplier firm through the network 15.

The information can be provided, for example, by obtaining contact (e-mail address) information of the supplier firm based on information identifying the supplier firm from the inter-firm transaction mediation site registered firms information database 4f. Then, the information is sent using e-mail.

Another example of a providing method is a method wherein the supplier firm selected in step 1800 can access the purchasing firm's requested transaction conditions information database 4c of the inter-firm transaction mediation system 10, and this supplier firm can obtain the target supplier solicitation conditions information stored in purchasing firm requested transaction conditions information database 4c. In this case, it is desirable to communicate in advance to the supplier firm by electronic mail and the like that there is a supplier solicitation conditions information to be provided. Furthermore, with this providing method, preferably, the firm trying to obtain the supplier solicitation conditions information is determined to be the supplier firm selected in step 1800 in advance by ID information or password information and the like. Only when the firm that is trying to obtain this supplier solicitation conditions information is the supplier firm selected in step 1800 can the target supplier solicitation conditions information be obtained.

As a more specific example of the this embodiment, a page for obtaining supplier solicitation conditions information is provided in the web page of the inter-firm transaction mediation site 11. On this page, ID information and password information for the firm can be entered and sent to the inter-firm transaction mediation system. Based on the firm ID information and password information that is sent to the inter-firm transaction mediation system, the information specifying the supplier solicitation conditions information that should be provided to the corresponding supplier firm is selected from negotiation candidate information database 4e. Based on this information for specifying the supplier solicitation conditions information that has been selected, the supplier solicitation conditions information that should be provided to this supplier firm is specified from purchasing firm requested transaction conditions information database 4c. This specified supplier solicitation conditions information is displayed on the web page.

(Step 2000)

Step whereby the supplier firm receives the supplier solicitation conditions information from the inter-firm transaction mediation site.

The supplier firm selected by inter-firm transaction mediation site 11 in step 1800 obtains through the network 15 the supplier solicitation conditions information from the inter-firm transaction mediation site 11 using the method described in step 1900.

(Step 2100)

Step whereby the supplier firm communicates the transaction desire to the interfirm transaction mediation site:

The supplier firm that has received the supplier solicitation conditions information from the inter-firm transaction mediation site 11 studies the content of this supplier solicitation conditions information and determines whether or not to submit a request for this supplier solicitation conditions information. If the supplier firm decides to apply, the supplier firm communicates to the inter-firm transaction mediation site 11 through the network 15 that it wishes to transact with the purchasing firm.

One contact method is to send electronic mail to the inter-firm transaction mediation site 11. Another contact method is to have the web page of the inter-firm transaction mediation site 11 provide a function for communicating whether or not a supplier firm will respond to the supplier solicitation conditions information that is provided to the supplier firm. For example, in the web page for providing supplier solicitation conditions information indicated as an example in the description for the previous step 1900, a “respond button” is provided for each supplier solicitation conditions information. By having the supplier firm push this button, a reply to this supplier solicitation is sent to the inter-firm transaction mediation system 10.

(Step 2200)

A step whereby the inter-firm transaction mediation site receives supplier candidate firms, and the information on the supplier candidate firms are provided to the corresponding purchasing firms as negotiation information:

With a supplier firm that has communicated a desire to transact with the purchasing firm in step 2100, the inter-firm transaction mediation system 10 of the interfirm transaction mediation site 11 receives this supplier firm as a supplier candidate firm for the associated purchasing firm. The information relating to the supplier firm as the supplier candidate firm is provided to the corresponding purchasing firm through the network.

An example of a method for providing the purchasing firm with information relating to the supplier firm as the supplier candidate firm is sending the information using electronic mail. In this case, the inter-firm transaction mediation system 10 receives the supplier firm that has communicated a desire to transact with the purchasing firm in step 2100 as a supplier candidate firm for this purchasing firm. The information identifying this firm (ID information and the like) is given temporary storage in the RAM 33. Information relating to the supplier firm as the supplier candidate firm is selected from the inter-firm transaction mediation site registered firms information database 4f and supplier firm's requested transaction conditions information database 4d. This selected information relating to the supplier firm as the supplier candidate firm is described or attached in an electronic mail to the corresponding purchasing firm. The information specifying the supplier firm that has communicated its desire to transact with the purchasing firm, or in other words the supplier candidate firm, has temporary storage in the RAM 33 as described above and is preferably stored in negotiation candidate information database 4e. The information specifying the target supplier solicitation conditions information is stored in association with the information specifying the supplier firm that matches this supplier solicitation condition.

As another example of a method for providing the purchasing firm with information relating to the supplier firm as the supplier candidate firm, a page intended for the purchasing firms for obtaining information on the supplier candidate firms can provided on the web page of the inter-firm transaction mediation site 11. More specifically, ID information and password information for a purchasing firm can be entered by the purchasing firm on the web page and can be sent to the inter-firm transaction mediation system 10. The purchasing firm is identified based on this sent ID information and password information of the purchasing firm. The information specifying the supplier solicitation conditions information that should be provided and the information specifying the supplier candidate firm that is stored in association with the information specifying this supplier solicitation conditions information are selected from the negotiation candidate information database 4e. Based on the selected information, the supplier solicitation conditions information that should be provided is selected from the purchasing firm's requested transaction conditions information database 4c. In addition, information relating to the supplier firm as the supplier candidate firm is selected from the inter-firm transaction mediation site's registered firms information database 4f and the supplier firm's requested transaction conditions information database 4d. This selected information is displayed on the web page.

(Step 2300)

Step whereby the purchasing firm receives negotiation information:

By the method described in step 2200 above, the supplier firm obtains negotiation information of information relating to the supplier candidate firm with respect to the supplier solicitation conditions information submitted by the purchasing firm to the interfirm transaction mediation site 11. This information is obtained from the inter-firm transaction mediation site 11 through network 15.

FIG. 35 shows a sample display screen of a terminal belonging to “Hitachi”, which is a purchasing firm. Here, there is shown a result where suppliers A, C, K have all requested to conduct a transaction with Hitachi in (Step 2100).

The steps from (Step 1900) to (Step 2100) are for confirming the intent for transaction of the supplier firm. They are not always necessary steps in the embodiments of the present invention.

(Step 2400)

A step whereby the purchasing firm decides on a negotiation partner and initiates negotiation:

Based on the information of the supplier candidate firm obtained in Step 2300, the purchasing firm decides whether or not to conduct negotiation. If negotiation is to be conducted, one or more supplier firms of the supplier candidate firms is selected for negotiation. There is contact with this firm using electronic mail or the like, and negotiation is initiated.

As described above, a system that implements the inter-firm transaction mediation method of the present invention can be constructed.

Next, the details of the quality calculation programs for implementing the interfirm transaction mediation method of the present invention will be described.

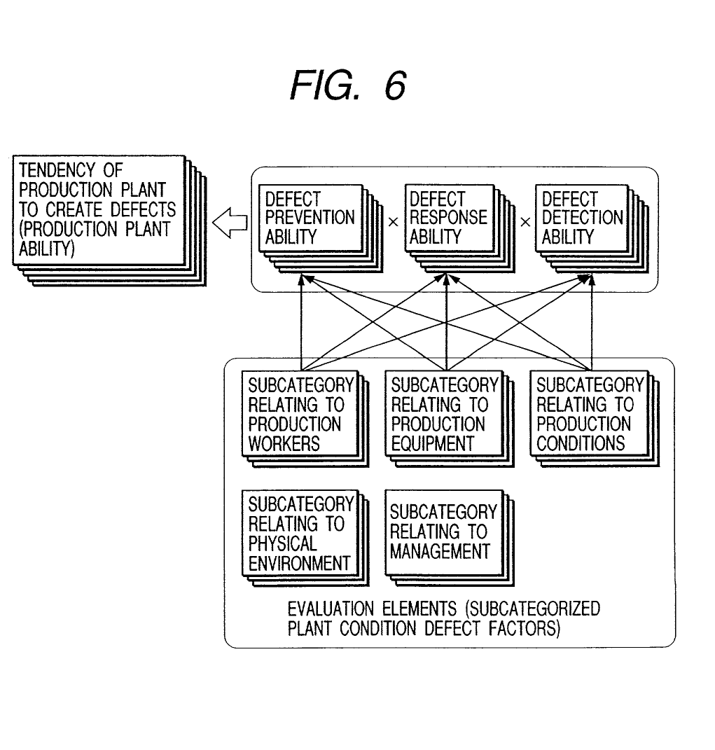

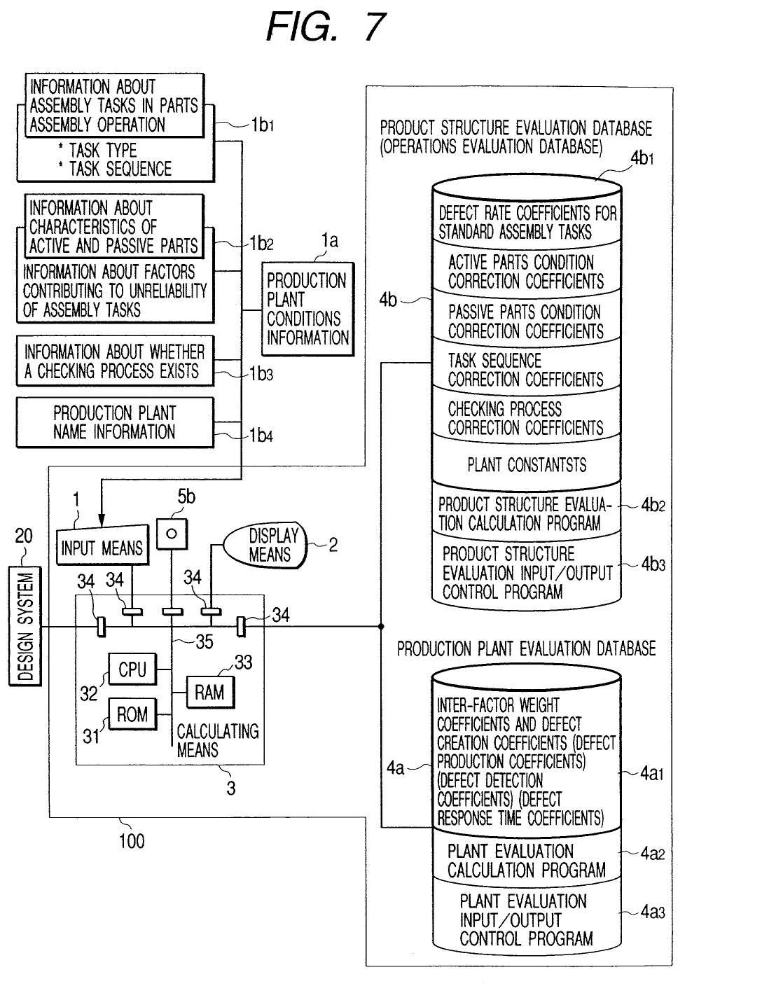

The quality calculation programs relating to the present invention can be installed and used on the computer serving as the inter-firm transaction mediation system 10 of the inter-firm transaction mediation site, or they can be installed and used in the computers of the firms participating in the inter-firm transaction mediation site. However, with either case, when the quality calculation program relating to the present invention is installed, the quality evaluation device based on the quality calculation programs has a device architecture as shown in FIG. 7. The details of the architecture are described later.

For the quality calculation programs according to the present invention, there is a “plant evaluation calculation program” for evaluating the capability for achieving quality for the supplied product of the plant of the supplier firm and a “product structure evaluation calculation program” for predicting manufacturing quality of the transaction product. These will be described below.

First, an embodiment of the evaluation performed by the “plant evaluation calculation program” will be described, with references to the figures.

By conducting a quantitative evaluation using the production plant evaluation method of the present invention, even without the actual data on defects, the likelihood of defects (degree of defect creation: defect creation rate) in the plant can be predicted. In other words, it was found that by quantitative evaluation using a production plant evaluation method, the present invention can approximately match the actual data on defects.

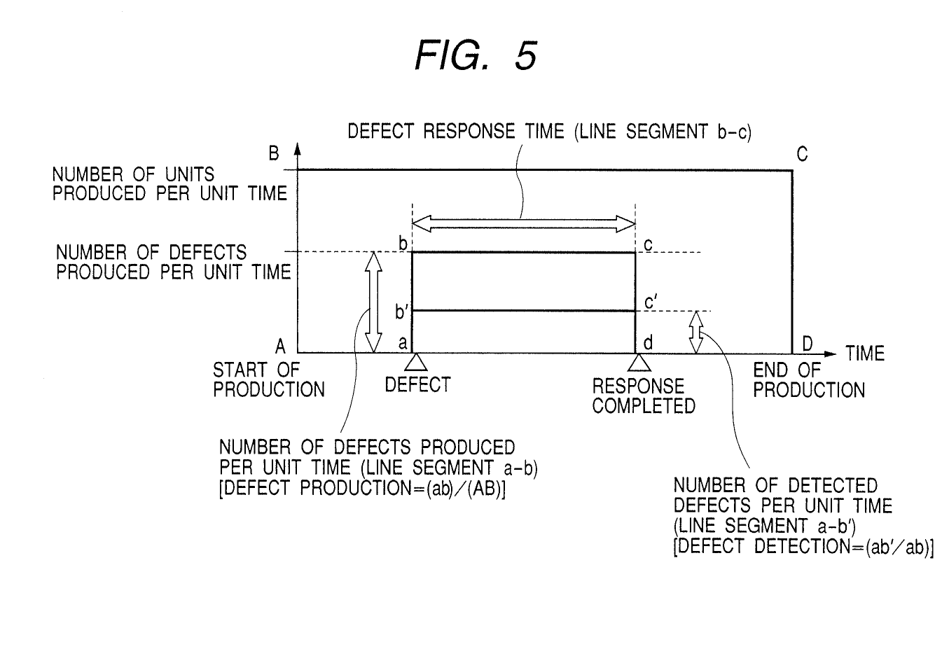

The likelihood of defects in a production plant (defect creation), or in other words the capability of the production plant, can be represented by [capability to prevent defects]×[capability to respond to defect creation]×[capability to detect defects].

[Capability to prevent defects] is the capability of a plant not to manufacture defective products, and as shown in FIG. 5, this can be represented as defect production=(ab)/(AB). [Capability to respond to defects] is the capability of a plant in preventing the generation of defective products by shortening the defect response time as much as possible when defects are created, and as shown in FIG. 5, this can be represented as the defect response time extent between the time of defect creation and the response completion time. [Capability to detect defects] is the capability of a plant to detect (take out) defective products so that defective products are not sent from the production plant to a plant for a later process, and as shown in FIG. 5, this can be represented by [defect detection rate]=(ab')/(ab).

By calculating the [capability to prevent defects]×[capability to respond to defect creation]×[capability to detect defects] with respect to standard manufacturing operations (in assembly operations, a standard assembly operation is, for example, the simplest downward moving operation), the capability of the production plant can be evaluated.

The production plant includes the following: the workers that conduct the manufacturing operation; the management that oversees these workers; the manufacturing facilities such as tools and jigs used in the manufacturing operation and the manufacturing line facility, and the like; and the plant environment, such as the temperature, humidity, brightness, noise and the like in which the workers and the like are present. Therefore, it became clear from our research that the factors for defect creation (defect creation categories) in the production plant can be divided into factors relating to the production workers, factors relating to the manufacturing facilities, factors relating to the manufacturing conditions such as manufacturing line speed and production lot number/unit time and the like, factors relating to the manufacturing physical environment, and factors relating to the management of the production plant, and the like.

However, there is no correspondence between these defect creation factors in the production plant and the [degree of defect production that is the capability to prevent defects], [extent of defect response time that is the capability to respond to defect creation], [the degree of defect detection that is the capability to detect defects]. Thereupon, there is a need to have finer classification into plant condition defect factors that could have a correspondence with [degree of defect production that is the capability to prevent defects], [extent of defect response time that is the capability to respond to defect creation], [the degree of defect detection that is the capability to detect defects].

For the plant condition defect factors (evaluation elements) of finer divisions relating to the production workers, there are the attendance rates of the production workers, the personalities and abilities of the production workers, the operation skill of the production workers, the operation instructional system for the production workers, and the like.

For the plant condition defect factors (evaluation elements) of finer divisions relating to the manufacturing facilities, there are the capability and reliability of the facilities, the management system of the facilities including maintenance, the extent of decisions of the responsible party with respect to the facilities, and the like.

For the plant condition defect factors (evaluation elements) of finer divisions relating to the manufacturing conditions, there is the production mode such as the manufacturing line speed, the product lot number/unit time, and the like.

For the plant condition defect factors (evaluation elements) of finer divisions relating to the manufacturing physical environment, there is the physical environment of temperature, humidity, brightness, noise, and the like.

For the plant condition defect factors (evaluation elements) of finer divisions relating to the management of the production plant, there are the education and training for the workers, operation instruction and assignment for the workers, method of response to defect creation, methods for checking operation, and the like.

As shown by the arrows in FIG. 6, by establishing plant condition defect factors (evaluation elements) that have finer classifications as described above, correlations with the “degree of defect production,” “extent of defect response time,” “degree of defect detection” become possible. A plant evaluation database 4a1 (shown in FIG. 7) comprises, for each of these factors, a defect production coefficient and a defect detection coefficient and a defect response time coefficient, which are defect creation coefficients at a standard level (for example, a high level in which the fewest defects are created) with respect to a standard manufacturing operation (in the case of an assembly operation, the standard assembly operation is the simplest downward moving operation), as well as a relative weighting coefficient between factors. Plant evaluation database 4a1 can be prepared in advance. By doing so, the tendency to generate defects (degree of defect creation) of the production plant, or in other words the capability of the production plant, can be predicted. In other words, by establishing the plant condition defect factors (evaluation elements) that have finer classifications, for each of these items, a defect production coefficient and a defect detection coefficient and a defect response time coefficient, which are defect creation coefficients at a standard level, and relative weighting coefficients between factors can be determined so that there are correlations with “defect creation”, “defect response time”, and “defect detection” with respect to a standard manufacturing operation. The relative weighting coefficient between factors can be built into the defect creation coefficients.

The plant evaluation database is created in the following manner. Using defect creation values relative to standard production operations according to plant condition defect factor levels as measured in representative production plants (i.e., defect production, defect detection, and defect response time), calculations are made to determine defect creation coefficients for each of the plant condition defect factors at reference levels (i.e., defect creation coefficients, defect detection coefficients, defect response time coefficients, and weighting coefficients). Of course, the tendency to create defects (defect creation) for the representative production plants will be measured as well, i.e., total defect creation and plant defect rates, which are values that indicate plant capability.

In this manner, based on actual measurements in a representative production plant, the plant evaluation database is created and prepared. Simply by entering level settings for each plant condition defect factor at various production plants, the capabilities (total defect creation, and plant defect rate) of that production plant can be evaluated and predicted. It has been confirmed by the present inventors that for several production plants other than the representative production plants the actual measurements and the predicted values approximately coincide.

As described above, simply by inputting levels for each plant condition defect factor for various production plants, the capability (total defect creation, and plant defect rate) of the production plant can be evaluated and predicted. The predicted capability of the production plant is registered as a plant constant (an index representing the capability of the reliability of the manufacturing operations in a production plant) in the product structure evaluating database (operation target evaluation database) 4b1. As a result, as described in Japanese laid open patent publication number Hei 10-334151, the defect rate of the product that is manufacture (for example, assembled) in the production plant can be predicted.

Next, an embodiment of a method will be described wherein, by simply inputting levels for each plant condition defect factor for various production plants, the capability (total defect creation and plant defect rate) of a production plant can be evaluated and predicted.

FIG. 7 shows a structural diagram showing an embodiment of a plant evaluation module 10a that evaluates and predicts the capability (total defect creation and plant defect rate) of the production plant and a product evaluation module (manufacturing operation evaluation module) that predicts the defect rate when a product or part of a product is manufactured at this production plant. Below, there will be a description of a situation when a product is manufactured by assembly. Japanese laid open patent publication number Hei 10-334151 describes a product evaluation module 10b that predicts the defect rate when manufacturing a product or part of a product at a production plant. This will be described briefly.

With the quality calculation program of the present invention, the program can be installed on the computer serving as the inter-firm transaction mediation system 10 of the inter-firm transaction mediation site. Alternatively, the program can be installed on the computer of firms that participate in the inter-firm transaction mediation web site. With either situation, when the quality calculation program of the present invention is installed, the quality evaluating device by the quality calculation program has a device architecture as shown in FIG. 7.

More specifically, a product structure evaluating database 4a and a production plant evaluation database 4b, which are databases for conducting quality calculations, are added to a general-purpose computer system. The quality evaluating device is constructed from: calculating means 3, constructed from a CPU 32 that is connected to a bus 35, a ROM 31 that stores the specified program, a RAM 33 that temporarily stores various data; input means 1, connecting to calculating means 3 via an interface 34; displaying means 2; a storage device 4; and output means 5b. Input means 1 is constructed from a keyboard, mouse, storage medium, a network and the like so that the following information can be entered: information 1b1 for assembly tasks in the assembly operation of the part, active/passive parts characteristics information 1b2 of the assembly part and assembly target, information 1b3 on the presence or absence of a checking process, information 1b4 of the production plant name, and production plant conditions information 1a for the evaluation of the production plant, and the like. Displaying means 2 is constructed so as to display the input screen for inputting various information with input means 1 and display the evaluation results of the production plant (analysis results and improvement advice and the like) and display the evaluation results (defect rate, defect details, and manufacturing costs, and the like) of the product structure (product operation). The storage device 4 is constructed from production plant evaluation storage section 4a that stores a production plant evaluation database 4a1, a production plant evaluation calculation program 4a2, and a production plant evaluation input output control program 4a3, and a product structure evaluation storage section 4b that stores product structure evaluation database 4b1, product structure evaluation calculation program 4b2, and product structure evaluation input output control program 4b3. Output means 5 can output evaluation results of the production plant and the evaluation results of the manufacturing structure. Output means 5 is provided separately from displaying means 2 and is constructed from a recording medium and network and the like. Furthermore, the quality evaluation device by the quality calculation program connects a design system 20 by a network or a recording medium and the like and is constructed so that design data of the product to be manufactured can be entered.

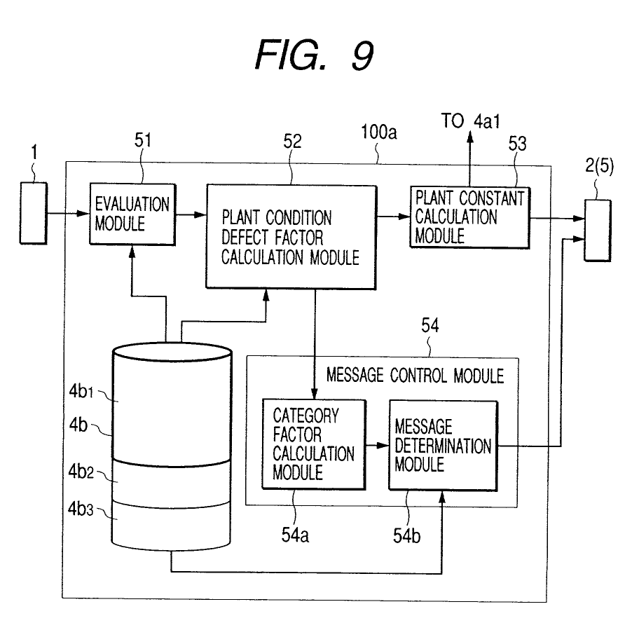

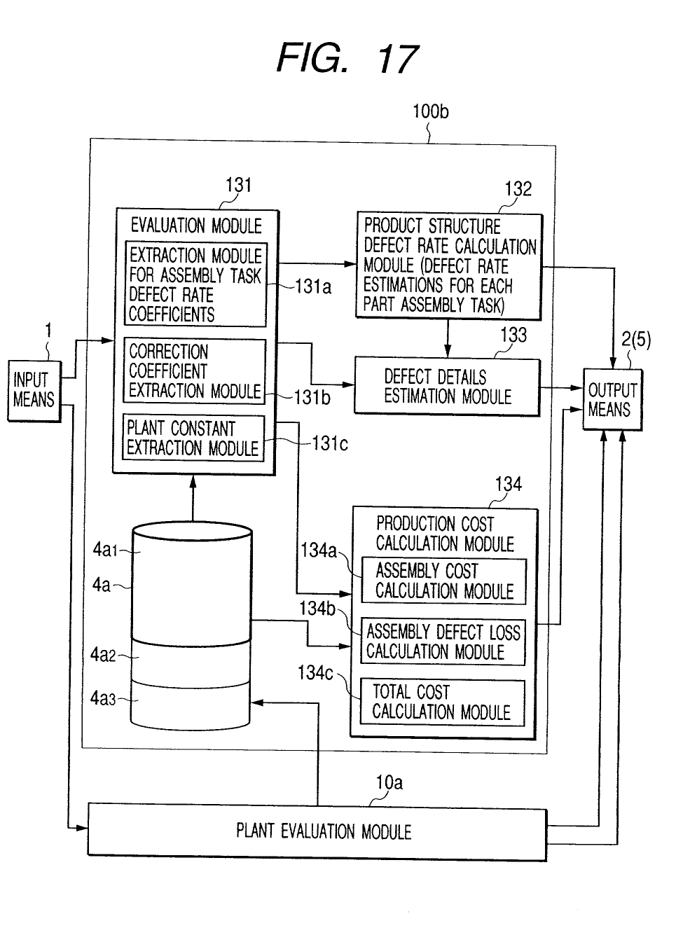

As described above, quality evaluating device 100 by the quality calculation program relating to the present invention is functionally largely constructed from a plant evaluation module 100a (shown in FIG. 9) that evaluates and processes the degree of defect creation of the production plant and a product evaluation module 100b (shown in FIG. 17) that evaluates the degree of defect creation of the product that is manufactured by the production plant. In the quality calculation programs of the present invention, plant evaluation can be conducted using only plant evaluation module 100a. However, functionally, by connecting with product evaluation module 100b, and by using evaluation information on the degree of defect creation of the production plant by plant evaluation module 100a and the evaluation of degree of defect creation of the product by product evaluation module 100b, a specific defect rate for when a certain product is manufactured at a certain production plant can be predicted.

By using this, the purchasing firm conducts an evaluation of the degree of defect creation of the product that is to be purchased using product evaluation module 100b. By deciding on the requested quality of the product, or in other words the requested defect rate, a lower limit for the evaluation index for the degree of defect creation of the plant satisfying this requested defect rate can be calculated. From this, by using the quality calculation programs of the present invention, the purchasing firm can calculate the requested quality of the product for purchase, in other words the requested defect rate, and the “lower limit for the evaluation index of the degree of defect creation of the plant” which is the capability for achieving quality for the supplier firms. This can be presented as a requested transaction condition.

By plant evaluation module 100a of the quality calculation programs of the present invention, the supplier firm can calculate the “evaluation index for the degree of defect generation of the plant” which is the capability for achieving quality of the production plant of the supplier firm, and this can be presented as a requested transaction condition.

The quality evaluation device 100 based on the quality calculation program of the present invention selects conditions (plant condition defect factors) that affect defect creation out of the various production plant conditions described above. Values are determined for each of the selected plant condition defect factors to indicate the degree to which the factor affects defect creation relative to a reference level for the plant condition and the magnitude of defect creation caused by the factor (“an relative weight coefficient” and a “defect creation coefficient” based on a “defect creation coefficient”, a “defect detection coefficient”, and a “defect response time coefficient”). These values are stored in the plant evaluation database 4a1. Based on information about the evaluations of the plant condition defect factor items from the plant conditions entered through inputting means 1, calculating means 3 reads the “defect creation coefficient” and the “relative weight coefficient” set up relative to the reference level of the plant for each of the defect factor items, and uses the “defect creation coefficient” and the “relative weight coefficient” to calculate a defect creation index and defect rate for the evaluated production plant for the plant condition defect factor items. This is then registered in the plant constant region in the product structure evaluation database 4b1 of the storage device 4.

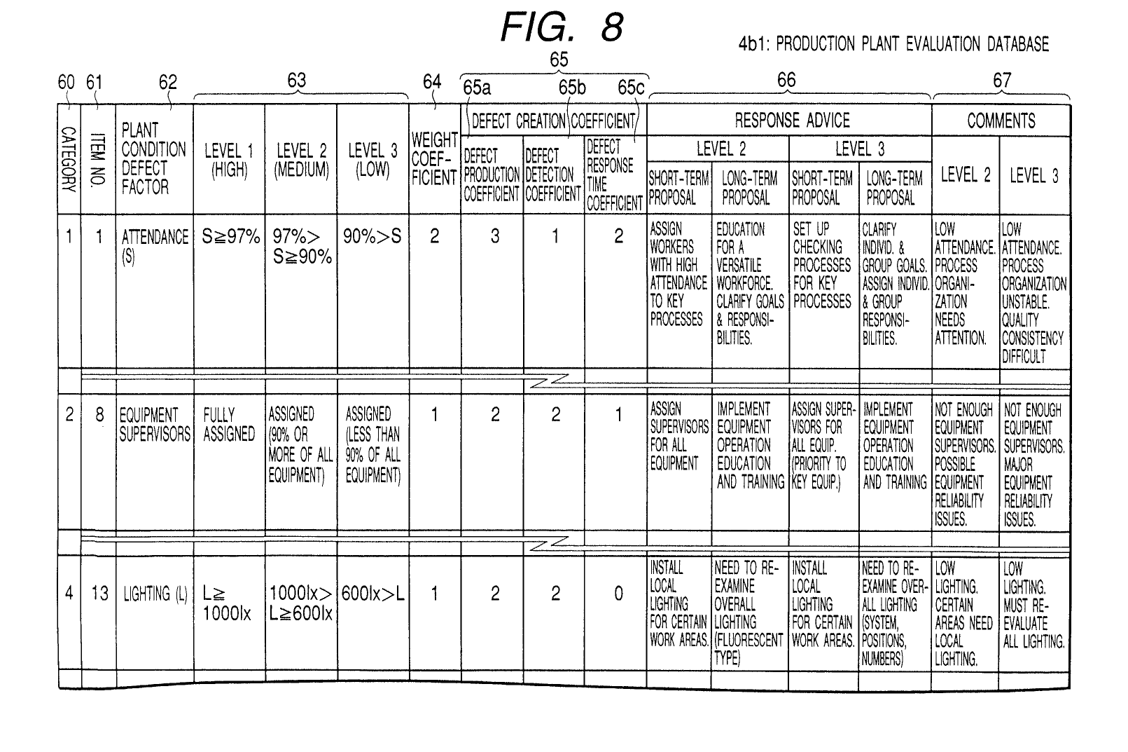

FIG. 8 shows the plant evaluation database 4a1 provided in advance in the plant evaluation storage section 4a of the storage device 4. The plant evaluation database 4a1 includes: fields 62, 63 containing information about plant condition defect factors from the defect factors (including field 63, which contains plant conditions for multiple plant levels); the “weight coefficient” 64 and the “defect creation coefficient” 65 based on the “defect creation coefficient” 65a, the “defect detection coefficient” 65b, and the “defect response time coefficient” 65c for the reference level (e.g., level 1) of the reference production operation set up for the plant condition defect factors,; and a field 66 for advice regarding improvements (countermeasures) for at least the defect creation factors or if the defect creation in a plant condition defect factor is significant.

In the example shown in FIG. 8, the plant condition defect factor (No. 1) subcategory of the evaluation category 1 (production workers) indicates attendance rates of production workers. The plant condition defect factor (No. 8) subcategory of the evaluation category 2 (production equipment) indicates equipment supervisor assignment. The plant condition defect factor (No. 13) subcategory of the evaluation category 4 (physical production environment) indicates brightness (lighting).

For each of the plant condition defect factors 62, multiple levels (plant levels) 63 are set up based on a reference level (e.g., level 1 (high level)). For example, for the “attendance rate” plant condition defect factor, three plant levels are set up: level 1 (high level) indicates “attendance rate 97% or higher”; level 2 (medium) indicates “attendance rate 90% or higher and less then 97%”; and level 3 (low) indicates “attendance rate less than 90%”. For example, for the “equipment supervisor” plant condition defect factor, three plant levels are set up: level 1 indicates “fully assigned”; level 2 indicates “assigned (90% or more of all equipment)”; and level 3 indicates “assigned (less than 90% of all equipment”. For example, for the “lighting” plant condition defect factor, three plant levels are set up: level 1 indicates “L>=1000 lx”; level 2 indicates “1000 lx>L>=600 lx”; and level 3 indicates “600 lx>L”. Thus, the example in FIG. 8 provides three levels, level 1 through level 3, in the plant level 63 set up for each plant condition defect factor, with level 1 corresponding to plant conditions that least tend to create defects, level 3 corresponding to plant conditions that most tend to create defects, and level 2 corresponding to plant conditions that tends to create defects at an intermediate level between level 1 and level 3. At least two plant levels are needed to indicate plant conditions, but there is no upper limit to the number of levels that can be used. Increasing the number of levels will improve evaluation precision but will also increase the number of input options, requiring more work in the input operation.

Furthermore, for each reference production task set up in the plant condition defect factors 62 (e.g., for assembly operations, the most simple task, downward motion, is used as a reference assembly task), there are entries for the “weight coefficient” 64 and the “defect creation coefficient” 65 based on the “defect creation coefficient” 65a, the “defect detection coefficient” 65b, and the “defect response time coefficient” 65c for the plant level (e.g., level 1). For example, for the “attendance rate” plant condition defect factor, the “weight coefficient” is set to “2” and, in the “defect creation coefficient” 65, the “defect creation coefficient” is set to “3”, the “defect detection coefficient” is set to “1”, and the “defect response time coefficient”0 is set to “2”. For the “equipment supervisor” plant condition defect factor, the “weight coefficient” is set to “1” and, in the “defect creation coefficient” 65, the “defect creation coefficient” is set to “2”, the ”defect detection coefficient” is set to “2”, and the “defect response time coefficient” is set to “1”. For the “lighting” plant condition defect factor, the “weight coefficient” is set to “1” and, in the “defect creation coefficient” 65, the “defect creation coefficient” is set to “2”, the “defect detection coefficient” is set to “2”, and the “defect response time coefficient” is set to “0”. A weight coefficient of “2” indicates that the defect creation is twice that of the other subcategories. Entries of “2” and 37 3” for the defect creation coefficient, the defect detection coefficient, and the defect response time coefficient indicate that the respective entries are twice or three times that of a “1”. If the defect creation coefficient, the defect detection coefficient, or the defect response time coefficient is “0”, it is not a factor in defects. In FIG. 8, these coefficients are all indicated as integers, but non-integers may also be used.

Furthermore, short-term proposals and long-term proposals are entered in the improvement advice field 66 and the comments field 67 for level 2 and level 3 defect creation if there is significantly high defect creation in a defect creation factor (evaluation category) or a plant condition defect factor subcategory for a production plant.

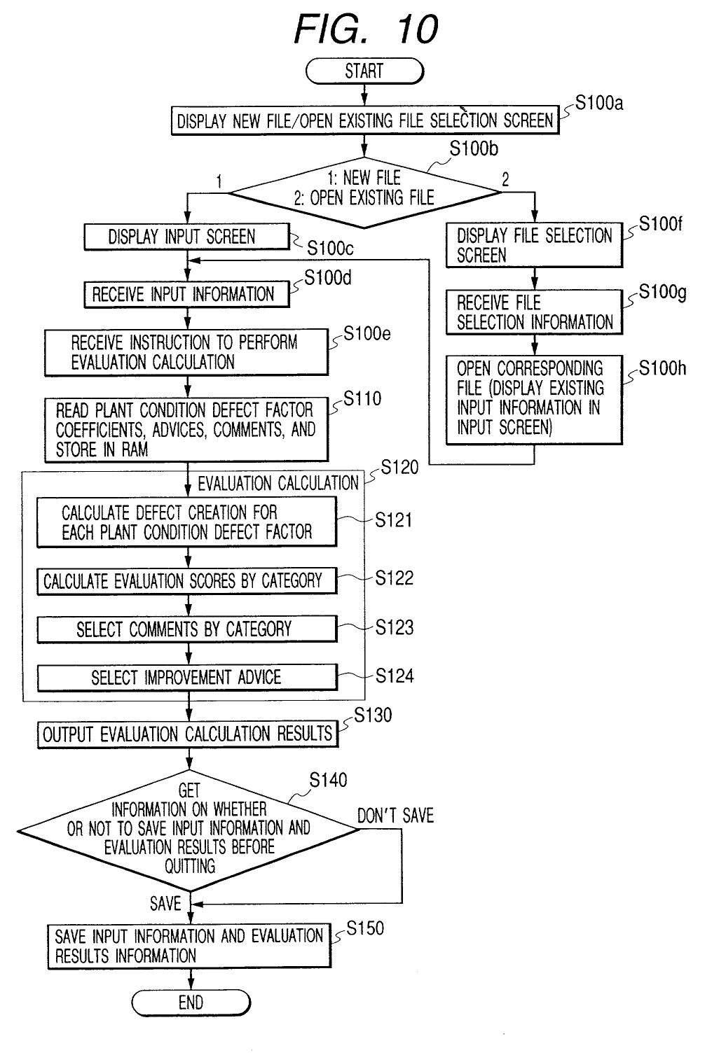

Next, FIG. 10 will be used to describe the flow of operations performed to evaluate and predict production plant abilities (total defect creation and plant defect rate) using the plant evaluation module 100a.

First, the production plant condition information 1a for the production plant to be evaluated is entered using inputting means 1 (step S100a-step S100h). More specifically, plant levels are selected and entered for each of the plant condition defect factors.

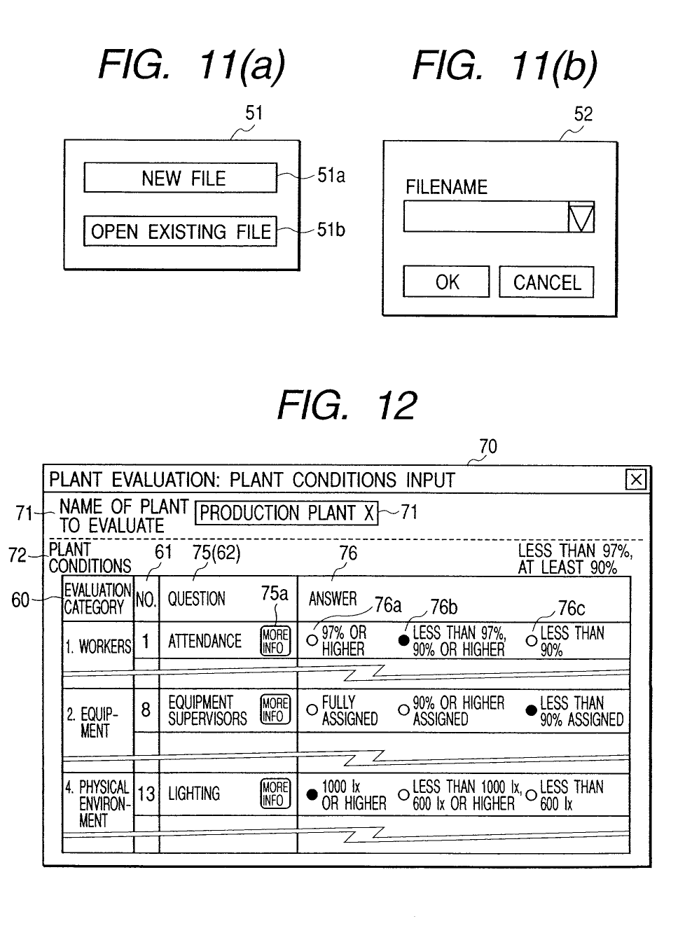

When an evaluator (e.g., a manager at the production plant) activates this evaluation device, a screen 51 is displayed on displaying means 2 as shown in FIG. 11 to allow the evaluator to select either “new entry” 51a or “open existing file” 51b (step S100a). An existing file can be opened if a new production plant is to be evaluated using an already evaluated production plant as a reference or if a production plant that has already been evaluated is to be reevaluated.

If the evaluator selects “new input” 51a (step S100b), this is acknowledged by calculating means 3 and an input screen 70, shown in FIG. 12, is displayed on displaying means 2 (step S100c). If the evaluator selects “open existing file” 51b (step S100b), a file selection screen 52, shown in FIG. 11(b), is displayed (step S100f). The evaluator indicates a filename to provide file selection information (step S100g), and the file (which contains information that had been entered through the input screen 70) is opened (step S100h).

Question topics 75 and response options 76, which serve as the input information, are read from the plant condition defect factor information 62 for each evaluation category and the plant level information 63, stored by levels for each plant condition defect factor. These are read from the plant evaluation storage section 4a of the storage device 4 and displayed on the input screen 70. As a result, evaluation items and plant level settings can be made simply by changing the information stored in the storage device 4. This allows the evaluation device to be easily maintained and improved.

The evaluator uses the input screen 70 and inputting means 1 to enter information about the plant being evaluated. This information is received by calculating means 3 and is temporarily stored in the RAM 33 (step S100e). First, “production plant X”, the name of the production plant to be evaluated, is entered. For each of the evaluation category questions (plant condition defect factors 62) 75, a detailed description button 75a can be pressed to show a description describing the question in a separate window. One of the plant levels 76a-76c in the response 76 is selected. In other words, for each question topic, i.e., plant condition defect factor, three response options (i.e., three plant levels) are displayed, and the evaluator can enter information simply by using a mouse to click the radio button corresponding to the plant condition of the plant being evaluated. In addition to using inputting means 1 such as a keyboard and mouse, it would also be possible to have plant information stored in a different storage device sent via a computer network. Also, the information can be sent to calculating means 3 by way of a storage medium such as a floppy disk. This can be done with a configuration that allows the information needed for an evaluation to be searched and read as needed.

After the evaluator has entered the information, the CPU 32, which serves as calculating means 3, determines that an evaluation calculation instruction has been issued. Based on the plant condition information entered and stored in the RAM 33 or the like, the CPU 32 reads the “weight coefficient” 64 and the “defect creation coefficient” 65, which includes the “defect creation coefficient” 65a, the “defect detection coefficient” 65b, and the “defect response time coefficient” 65c and temporarily stores this information in the RAM 33 (step S110).

In the plant evaluation module (calculating means 3 including the CPU 32) 100a shown in FIG. 9, an evaluation module 51 evaluates the plant level information entered using input means 1 for each plant condition defect factor, searches the plant evaluation storage section 4a of the storage device 4 to find the “weight coefficient” 64 and the “defect creation coefficient” 65 using information about the number indicating the plant condition defect factor sub-category and information about the plant level. These are stored temporarily in the RAM 33. These operations are repeated for all the plant condition defect factors to be evaluated.

The following description will refer to the input information shown in FIG. 12. In the plant condition defect factors, a plant level “2” is entered for “attendance”, a plant level “3” is assigned to “equipment supervisors”, and a plant level “1” is assigned to “lighting”. With these entries, the CPU 32 in the plant evaluation module 10a determines that the levels are “level 2”, “level 3”, and “level 1” for the plant condition defect factors number “1 ”, “8”, and “13”. Using the plant condition defect factor numbers “1”, “8”, “13” and the planet level information “level 2”, “level 3”, and “level 1” as search keys, the defect creation coefficient database in the plant evaluation storage section 4a of the storage device 4 is searched for information about the corresponding plant level coefficients (defect creation coefficients), the “weight coefficient” 64 and the “defect creation coefficient” 65, which includes the “defect creation coefficient” 65a, the “defect detection coefficient” 65b, and the “defect response time coefficient” 65c. This information is stored in the RAM 33. In the database shown in FIG. 8, the plant level in the plant level coefficient (defect creation coefficient) corresponds to the plant level relative to the reference plant level.

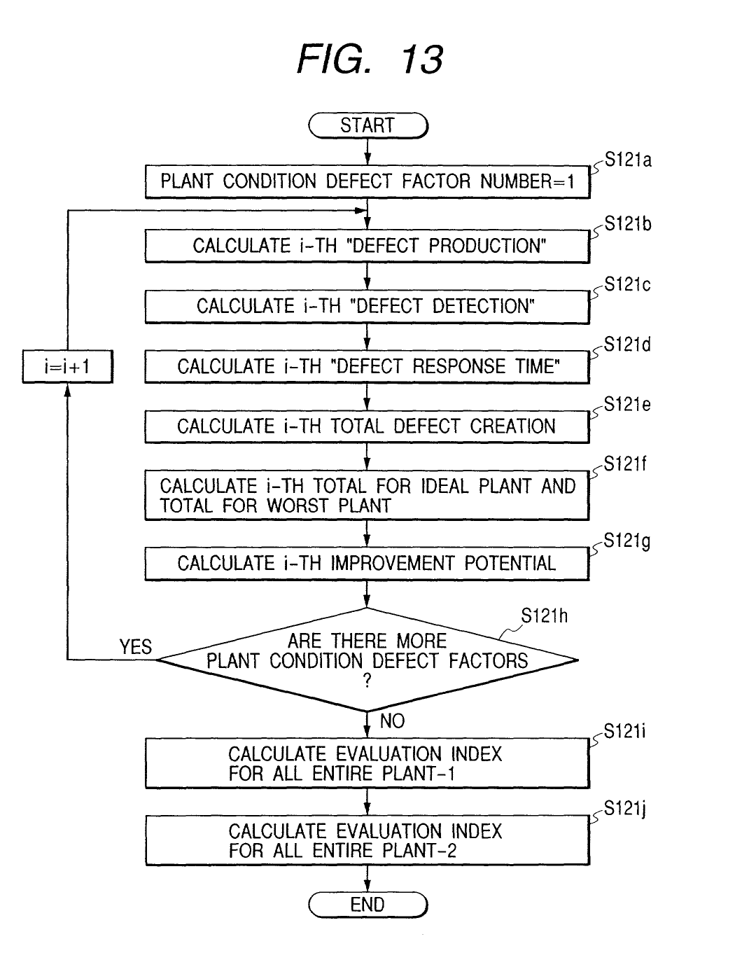

Next, as shown in FIG. 13, at step S121a, the plant condition defect factor number i is set. The CPU 32 of the calculating means 3 (the plant condition defect factor calculation module 52 from FIG. 9) runs the plant evaluation calculation program stored in the plant evaluation storage section 4a. Using the plant level coefficients relative to the reference plant level (defect creation coefficients) (indicated as plant levels in FIG. 8) for each plant condition defect factor for production plant X stored in the RAM 33—i.e., the weight coefficient 64 and the defect creation coefficient 65, which includes the “defect creation coefficient” 65a, the “defect detection coefficient” 65b, and the “defect response time coefficient” 65c—the CPU 32 calculates, for each plant condition defect factor, the defect creation index 92 (the “defect creation index” 92a (step S121b), the “defect detection index′ 92b (step S121c), the “defect response time index” 92c (step S121d), the “defect creation index” 92d (the sum of the “defect creation index”, the “defect detection index′, and the “defect response time index” 92c) (step S121e), and the “improvement potential” 92e (step S121g)), the “ideal plant defect creation index” 93a, and the “maximum defect creation index” 93b (step S121f). These values are stored temporarily in the RAM 33.

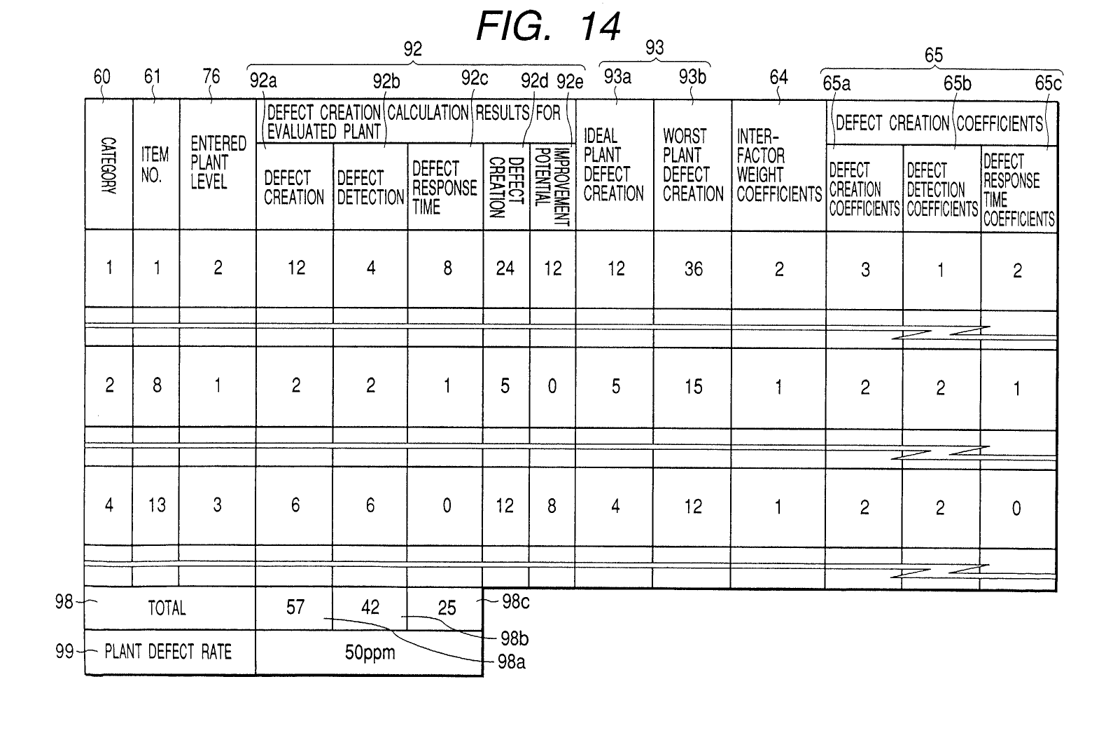

The “ideal plant defect creation index” 93a indicates, for example, the defect creation index for the plant level 1 (highest level). The “maximum defect creation index” 93b indicates the defect creation index for the plant level 3 (lowest level”. The “improvement potential” 92e is the difference between the “defect creation index” 92d and the “ideal plant defect creation index” 93a. For example, if the evaluation category shown in FIG. 14 is “1”, the plant level is “2” and the weight coefficient is “2”. Thus, the “defect production index”, the coefficients for “defect detection index”, and the “defect response time index” would be four times the defect creation coefficient (“3”), the defect detection coefficient (“1”), and the defect response time coefficient (“2”). Thus, the “defect creation index” would be the total of these values, “12 ”[?“24”?]. Since the “ideal plant defect creation index” is “12”, the “improvement potential” is “12”.

The CPU 32 of calculating means 3 (the plant constant calculating module 53 from FIG. 9) calculates the totals of all the evaluation categories for each of the plant condition defect factors at step S121h. As shown in FIG. 14, this provides the “defect creation index” sum 98a, the “defect detection index” sum 98b, and the “defect response time index” sum 98c, as well as a total sum 98. These values are stored temporarily in the RAM 33 (step S121i). Next, the CPU 32 of calculating means 3 uses the total sum 98 of the “defect creation index”, the “defect detection index”, and the “defect response time index” stored in the RAM 33 to calculate a plant defect rate 99. This is stored in the plant constant section of the product structure evaluation database 4b1 of the work evaluation storage section 4b of the storage device 4. As shown in FIG. 14, an evaluation estimate of the capabilities for the production plant X being evaluated (the defect creation index sum 98 and the plant defect rate 99) is made and is stored in the plant constant section of the product structure evaluation database 4b1.

Each production plant will have production task that it is strong in (e.g., assembly tasks) and production tasks that it is weak in (e.g., assembly tasks). This can be reflected in plant evaluations by storing multiple plant constants rather than just one plant constant in the plant constant section of operation evaluation database 4b1. For example, production operations can be divided into different production tasks (“insertion”, “soldering”, “securing with screws”, and the like for assembly tasks). Plant constants can be set up for each of these categories. This requires that the plant evaluation module 100a evaluate defect tendencies for each plant operation based on the corresponding plant condition defect factors. Information about plant operation types for categorizing the plant needs to be entered for the production plant condition information 1a, which is the input information for production plant evaluations. Of course, evaluation of products will involve more detailed production plant name information or production task type information in the input information for the production plant name information 1b4.

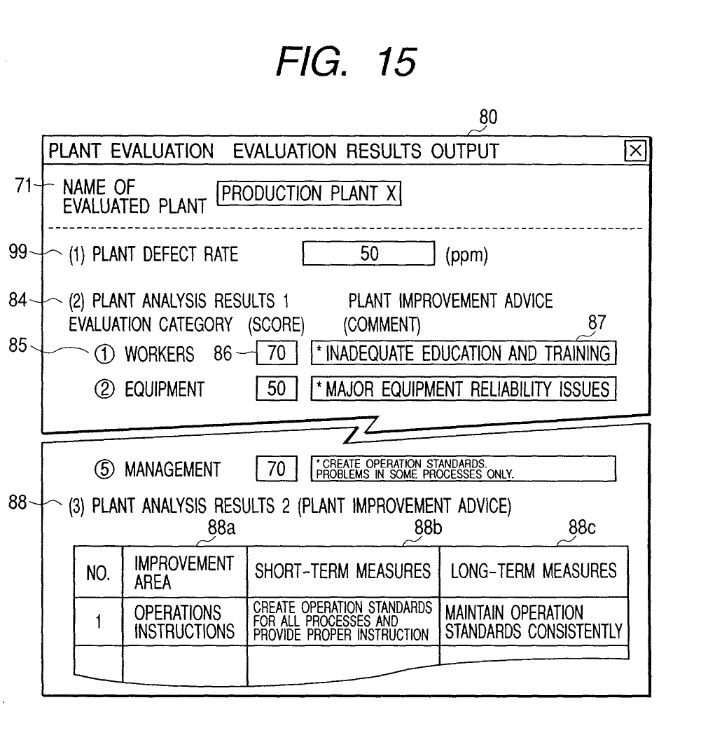

When displaying the evaluation calculation results for the evaluation of the production plant X at step S130 using, for example, displaying means 2, it is possible to display, in addition to the plant defect rate 99, plant analysis results 1 (an evaluation score 86 by category and comments 87 by category), plant analysis results 2 (advice for improvements), and the like, as shown in a screen 80 in FIG. 11 [?FIG. 15?]. To do this, at step S122, the CPU 32 of calculating means 3 (the message control module 54 and the category factor calculation module 54a) calculates, for each evaluation category, a ′defect creation index” sum, a “defect detection index” sum, a “defect response time index” sum, and a total sum (defect creation index). An evaluation score (defect rate) is determined using the calculated defect creation index and, for example, can be stored in the storage device 4. Next, at step S123, the CPU determines, for each evaluation category, the plant condition factor with the largest value for the “improvement potential” 92e, and retrieves comments corresponding to this plant condition defect factor from the plant evaluation database 4a1. This can then be stored, for example, in the storage device 4. Then, at step S124, multiple plant condition defect factors with the highest values in “the improvement potential” 92e are selected and improvement advice is retrieved from the plant evaluation database 4a1 based on the selected plant condition defect factors and the plant levels entered for these factors. Thus, at step S130, the evaluation calculation results from the evaluation of the production plant X are output, and improvements can be made. In particular, the evaluation score for the different evaluation categories can be displayed as a pie chart or graph or the like to provide a quick visual guide to different factors.

As described above, the necessary data from the estimated evaluation results for the production plant X is saved in the storage device 4.

An example of the output screen from the plant evaluation module 100a according to the present invention is shown in FIG. 15. In the sample output in FIG. 15, three evaluation results are shown:

(1) A “plant level defect estimation value” indicating the defect creation index.

(2) Plant analysis results 1

(3) Plant analysis results 2

The “plant level defect estimation value” from (1) is an estimated average defect rate for reference production operations at the evaluated production plant X. This allows defect creation comparisons to be made between production plants.

In addition, two types of plant analysis results are output. First, the plant analysis results 1 provides an evaluation score of the plant level for each evaluation category. This evaluation score can, for example, be based on the sum of the coefficients in each evaluation category for the evaluated production plant X, where the ideal production plant has a score of 100 and a production plant at the lowest level has a score of 0. The plant analysis results 2 provide advice for plant improvement. The plant condition defect factors with the highest improvement potential, i.e., the ones for which improvement would provide the greatest defect creation reduction, are shown as “plant improvement issues”, and proposed responses for both short-term and long-term objectives are shown. These responses are stored separately in the plant evaluation database 4a1 of the storage device 4 as short-term responses and long-term responses for the different plant condition defect factors.

If necessary, it would also be possible to have separately stored short-term and long-term proposed responses for combinations of plant levels in multiple plant condition defect factories.

Also, in order to provide efficient and appropriate measures, it would be desirable for items to be displayed by descending order of improvement potential, beginning with the highest improvement potential value, i.e., improvements that would be most effective in decreasing defect creation.

The above operations make it possible to provide highly reliable production plant evaluation results using simple input operations. Also, these evaluation results include output of production plant condition items (i.e., plant improvement issues) starting with the ones with the highest improvement potential. This allows effective production plant improvements to be undertaken immediately.

By using the plant evaluation module 100a in this manner, a quantitative assessment can be made of an evaluated production plant's defect tendencies (capabilities) even if the production plant does not actually produce the products.

Also, the production division can determine the plant conditions in the production plant that are a significant factor in defect creation and can quantitatively assess the degree of defect reduction that can be provided through improvements in these plant conditions. Thus, production plant improvement plans can be set up to effectively improve the plant level, and defect creation can be prevented. Also, if an evaluation is performed before production, the important management issues for the production plant can be clarified beforehand. This allows appropriate inspection processes and inspection methods to be selected, thus providing effective defect detection. Also, in the design/development division, defect creation at the production plant where a product is to be made can be predicted. This allows product development/design to take place to suit the production plant.

The following is a brief description of an embodiment in which the production evaluation module 100b estimates a defect rate for a product to be produced (e.g., assembled) in a production plant. This estimate will be based on the defect rate 99 for the production plant that will be producing the product, as stored in the plant constant section of the operation evaluation database 4b1 as described above.

Out of the different operations involved in producing a product, the following description will cover the assembly operation.

The design system 20 provides information about part names, part numbers, materials, weights, unit prices for the parts used in the product. If a quality calculation program is installed in the inter-firm transaction mediating system 10 according to the present invention, the above information will often be provided not from the design system 20 but from firms participating in the inter-firm transaction mediation site by way of communication means and networks.

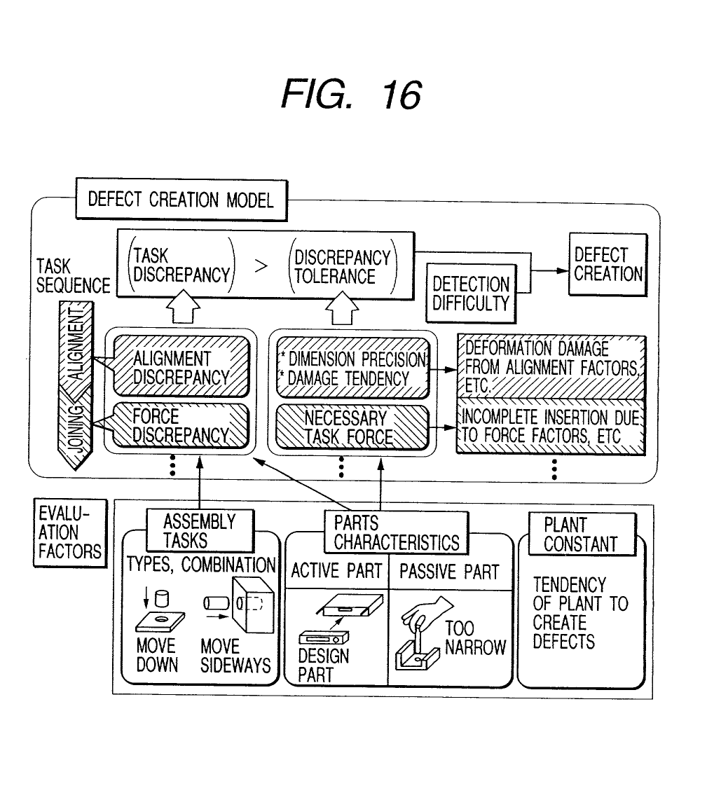

FIG. 16 shows the product defect model according to the present invention. The sequence in one assembly operation is an “alignment task”, followed by a “joining task”. In other words, one assembly operation consists of the “alignment task”, followed by the “joining task”. Defect creation can take place when “task discrepancy” exceeds a “discrepancy tolerance” without the defect being discovered. “Task discrepancy” results from characteristics of the parts and assembly tasks and includes “alignment discrepancy” taking place during the “alignment task” and “force discrepancy” taking place during the “joining task” and the like.

Based on the characteristics of the part, “discrepancy tolerance” is determined by “dimensional accuracy, damage tendency, and the like” in the “alignment task”, and “necessary task force” in the “joining task”. Defect creation resulting from “alignment” includes deformation damage and the like. Defect creation resulting from “force” includes incomplete insertion and the like.

As described above, a single assembly operation can be considered as a repetition of “alignment tasks” and “subsequent joining tasks”. Standard assembly tasks will include stand-alone “alignment tasks” such as supporting a part or shaping a wire, but most assembly operations involve “alignment” and then “joining”.

Thus, a standard assembly task is formed from “alignment tasks” and “joining tasks”, and causes many defect operations. These problems can be divided into those caused by alignment tasks and those caused by joining tasks.

First, defects resulting from alignment tasks are defects caused by discrepancies (inaccuracies) in the position or orientation of parts during the alignment tasks. If the joining task is performed with inadequate alignment, a joining task defect (incomplete operation defect) is the result. However, depending on joining strength between the active and passive parts and the task force used in this task, the defect can lead to damage defects and deformation defects at the joined section. In general, an operator will proceed to the joining task after confirming adequate alignment. If alignment is inadequate, the alignment will be corrected before proceeding to the joining task. Defects will tend to be created especially when alignment confirmation is difficult, e.g., the position is difficult to see, or when alignment confirmation is accidentally skipped.

In addition, assembly defects resulting from the joining task include inadequate path control in the joining task, i.e., discrepancies in the task path, and inadequate joining task force. Assembly defects from inadequate joining task path control are especially common in long-path tasks. Assembly defects from inadequate joining task force are especially common when the task force needed for assembly cannot be provided, particularly when the required task force is high as in insertion tasks or the characteristics of the part or task prevents a predetermined task force from being applied.

Thus, the assembly operation for the product or parts to be evaluated consists of multiple assembly tasks in which multiple parts are assembled in sequence. Thus, an assembly operation can be expressed in terms of combinations of standard assembly tasks (e.g., downward motion, lateral motion, inversion, insertion, soldering, shaping) set up in advance. The assembly defect tendency (defect rate) of the assembly operation for the product or parts to be evaluated can be calculated by taking the sum of defect rate coefficients of these standard assembly tasks. These defect rate coefficients for standard assembly tasks can be corrected using correction coefficients. The correction coefficients can be based on: the number of assembly tasks needed to complete an assembly operation; characteristics of the active/passive parts (e.g., function (part type, such as design part), size, weight, shape (active part characteristics include very small part and multiple assembly orientation (multiple simultaneous alignments) while passive part characteristics include very small hole/small hole, assembly completion evaluation, number of alignment positions, space around assembly section, no alignment guide, assembly to moving part, and the like); assembly plant conditions (plant constants); and presence of checking process to confirm completion of assembly. This correction improves the accuracy of the predicted assembly defect tendency (defect rate) in the assembly operation for the product or parts to be evaluated.

Thus, the item to be evaluated is expressed as a combination of standard assembly tasks. Defect rate coefficients for the different standard assembly tasks are corrected based on the number of assembly tasks, the characteristics of the active and passive parts, assembly plant conditions, and whether or not there is a process for checking assembly completion.

The reason for determining the assembly defect rate in the parts assembly operation based on the tasks in the assembly operation, the characteristics of the active and passive parts, whether or not there is a process for checking assembly completion, and the conditions of the plant in which assembly operations are performed is as described below.

Any assembly task obviously brings up the potential (assembly defect rate coefficient) for creating an assembly defect. The tendency to create defects is found primarily in assembly tasks.

Factors that can increase or decrease assembly defect rate coefficients of assembly tasks include characteristics of the active and passive parts and conditions of the plant in which the assembly operation is performed.

Regarding the characteristics of the active and passive parts, for example, if the shapes of the active and passive parts make assembly difficult, the assembly defect rate coefficient for the assembly task will be increased. The reason part types (functions) of the active and passive parts can be entered is as follows.

Assembly defects can be broadly divided into two categories: incomplete assembly and parts damage/soiling. “Incomplete assembly” takes place primarily due to human error and discrepancies in manual tasks (discrepancies in task accuracy). Using a connector insertion operation as an example, this type of defect includes “incomplete insertion (not inserted all the way in)” and “connector inserted with the left and the right sides reversed”. “Parts damage/soiling” is also primarily due to human error and discrepancies in manual operations (discrepancies in task accuracy), but whether or not it will be a “parts damage/soiling” defect can depend on the part type even if it involves the same damage/soiling. For example, slight damage or soiling to a design part exposed to the outside can be a defect unlike other parts inside the product.

In other words, even if the same external force (stress) is applied when a task is carried out, whether or not a part will be a defect or not depends on the part type, i.e., the function of the part. Thus, coefficients expressing the resistance of each part type to external force is contained in the database. The part types of active and passive parts can be input, and the calculation of the defect rate estimate takes into consideration the probability of “part damage/soiling” defects by comparing the evaluated part's resistance to external force (stress) and the external force (stress) applied to the part in the assembly operations for the part.

Similarly, the assembly defect rate coefficient of an assembly task is affected by the conditions of the plant where the assembly operation is performed. For example, even with the same assembly task, the defect rate coefficient will be higher if the equipment used in the task tends to produce defects. Conversely, the defect rate coefficient will be lower if the overall technical level of the operators at the plant is higher.

Also, in terms of defect discovery potential, placing a checking process to check whether an assembly operation has been completed properly after the assembly process for which a assembly defect rate is being estimated will allow a defect to be discovered if one is created. By repairing the defect in such cases, the final defect probability can be reduced.

For these reasons, the product evaluation module 100b calculates the defect rate based on the following factors that are significant in assembly defects: the tasks performed in the assembly operation; the characteristics of the active and passive parts; the presence of a checking process for checking to see if the operation was completed properly; and conditions of the plant where the assembly operation is performed.

Thus, the product structure evaluation storage section 4b of the storage device 4 includes: the product structure evaluation database 4b1; a section 4b2 for storing a product structure evaluation calculation program containing equations for calculating defect rates for the product evaluation module; a section 4b3 storing a product structure evaluation input/output control program; and the like. The product structure evaluation database 4b1 stores: defect rate coefficients for different standard assembly tasks based on the types of standard assembly tasks (tasks to assemble parts); task sequence correction coefficients based on the number of assembly tasks (referred to as the assembly count) needed to complete an assembly operation; active and passive part condition correction coefficients based on characteristics of the active and passive parts and the like; a checking process correction coefficient for when a process for checking assembly completion is set up after the assembly operation; and plant constants based on conditions in the plant where the assembly operation is performed.

First, an input screen is displayed on displaying means 2, and input means 1 is used to enter the following information, shown in FIG. 7, related to assembly tasks: assembly task information 1b1(types of tasks, sequence of tasks); active/passive parts characteristics information 1b2 (information about factors affecting unreliability in assembly tasks); checking process presence information 1b3; and plant name information 1b4 of the production plant where the assembly operation is performed. This information is temporarily stored in the RAM 33.

Then, the CPU 32 (the extraction modules 131a-131c of the evaluation module 131 shown in FIG. 17) extracts from the database 4b1 the standard assembly task defect rate coefficients associated with the standard assembly task elements that were input. Correction coefficients corresponding to the assembly numbers (sequence of standard assembly tasks) for each of the standard assembly tasks that were input are extracted from the task sequence correction coefficients stored in the database 4b1. Correction coefficients corresponding to the characteristics of the active and passive parts in the standard assembly tasks that were input are extracted from the active parts conditions and the passive parts correction coefficients stored in the database 4b1. A correction coefficient based on the presence of a checking process in the standard assembly tasks that were input is extracted from the checking process correction coefficients stored in the database 4b1. A correction coefficient corresponding to the production plant name where the standard assembly tasks that were input is extracted from the plant constants stored in the database 4b1. These values are stored temporarily in the RAM 33.

Next, the CPU 32 (the product structure defect rate calculation module 132 shown in FIG. 17) uses the product structure evaluation calculation program stored in the section 4b2 to calculate an estimated product assembly defect rate. This is done by taking the sum of the estimated defect rates for each of the parts assembly task based on the assembly defect estimation equation in (Expression 2), which is based on the equation in (Expression 1).

Estimated product assembly defect rate=Σf1(assembly tasks, assembly count, parts characteristics, plant conditions, presence of checking process) (Expression 1)

Σf2(assembly task defect rate coefficient, task sequence correction coefficient, parts correction coefficient, plant correction coefficient, checking process correction coefficient) (Expression 2)

In the expressions above, f1( ) and f2( ) represent functions. These functions can involve, for example, multiplying or adding/subtracting the task sequence correction coefficient, the parts correction coefficient, the plant correction coefficient, and the checking process correction coefficient to the assembly task defect rate coefficient. Alternatively, correction can be applied using an exponential function or the like.

Also, a single assembly task may have multiple task sequence correction coefficients, parts correction coefficients, plant correction coefficients, and checking process correction coefficients. In such cases, correction can be performed by multiplying all of the task sequence correction coefficients, parts correction coefficients, plant correction coefficients, and checking process correction coefficients to the assembly task defect rate coefficients. Another possible system is to add (or subtract) the task sequence correction coefficients, parts correction coefficients, plant correction coefficients, and checking process correction coefficients.

The present invention can use any of these methods as long as the assembly task defect rate coefficient is corrected using the task sequence correction coefficients, parts correction coefficients, plant correction coefficients, and checking process correction coefficients.

In assembly operations expressed as multiple standard assembly task elements, the complexity of an operation increases as the number of tasks increases. The task sequence correction coefficient in the database 4b1 is a correction coefficient that increases the “basic assembly task defect rate coefficient” for individual tasks according to the sequence of the assembly tasks in the larger assembly operation.

Furthermore, the tendency to create defects in each of the assembly tasks is also affected by conditions of the active and passive parts as well as their peripheral parts. This is taken into account with the part condition correction coefficient. In other words, the tendency for defects in individual assembly tasks will vary according to characteristics of the active part such as the size, weight, material, number of joinings, and the like of the active part. The tendency will vary according to characteristics of the passive part as well. Based on the above, active part characteristics factors and passive part characteristics factors, which have an important effect on operation defects in assembly operations, are set up in an active part conditions correction coefficient database and a passive part conditions correction coefficient database in the database 4b1. For each factor, there is a part conditions correction coefficient for correcting the standard assembly task defect rate coefficient. The active part conditions correction coefficient database and the passive part conditions correction coefficient database can be formed with different database structures.

Furthermore, the tendency toward task defects in the different assembly tasks varies significantly depending on the conditions of the production plant in which the assembly operation is performed. Thus, plant constants are stored in the database 4b1 to indicate the average defect tendency in production plants (production plant capability index), as provided by the production evaluation module 100a, for reference assembly operations (reference production operations) such as “downward motion”. The plant constants indicate the average defect tendency in a production plant (production plant capability index), but a production plant is not limited to a single plant constant. It would be possible to have a series of assembly tasks divided into multiple assembly tasks, and a plant constant can be calculated by the plant evaluation module 100a and stored in the database 4b1 for each of these multiple assembly tasks. In other words, multiple plant constants can be determined by the plant evaluation module 100a and stored in the database 4b1. As a result, the plant correction coefficient, i.e., the plant constant, can be changed for each set of multiple assembly tasks in (Expression 2) above.

Since the defect rate decreases if a checking process is provided to determine proper assembly after a parts assembly operation for which an assembly defect rate estimation is being made, the checking process correction coefficient provides correction to reflect this. If defect detection rates vary depending on the type of checking operation used, a checking process correction coefficient can be set up for each different checking process. The checking process presence information 1b3 is not always needed, and the desired defect rate can be calculated without this information.

When estimating a defect rate of a product as described above, it is assumed that the parts themselves are not defective. However, since the parts themselves also have defect rates, a true product defect rate can be calculated by taking the defect rates of the parts into consideration. Since the defect rates of parts are based on plant producing the parts or the management performed by the manufacturer, correction coefficients can be calculated from the defect rates of the parts themselves in a similar manner as the evaluation of the production plant. This would then be stored in association with the part name in the product structure evaluation database 4b1.

Next, a defect estimation module (CPU 32) 133 in the product evaluation module 100b will be described. The product structure defect rate calculation module 132 calculates the corrected sum of defect rate coefficients or defect rates for each assembly task. In the defect estimation module 133, multiple sum, e.g., the largest sums, are selected out of these calculated sums of defect rate coefficients or defect rates. This allows the assembly tasks believed to be causing the most defects to be selected. Then, the defect estimation module 133 determines whether the defect is due to an “alignment task”, a “joining task”, or the like by searching the defect rate coefficients, the task sequence correction coefficients, the parts correction coefficients and the like that determine the sum of defect rate coefficients by assembly operation.

The following is a description of a production cost calculation module (CPU 32) 134, formed from an assembly cost calculation module 134a, an assembly defect loss calculation module 134b, and a total cost calculation module 134c. The unit prices of parts are input through the design system 20 and stored in the product structure evaluation database 4b1. The product structure evaluation database 4b1 also stores: operation times required for standard assembly tasks; operation time correction coefficients corresponding to the coefficients for active part conditions, passive part conditions, task sequences, and checking process presence; fees per unit operation time based on production plant constants. Thus, the assembly cost calculation module 134a can calculate assembly costs based on operation times, operation time correction coefficients, and fees per unit operation time based on production plant constants for different standard assembly tasks. Also, since the defect rate for the entire product and the total defect rates for the different assembly operations have been calculated, the assembly defect loss calculation module 134b can calculate an estimated assembly defect loss based on the operation time needed to disassemble and replace defective parts with good parts and reassemble the product. In doing this, the unit price of good parts and the fees involved in disposing bad parts must be taken into account. Also, if defective parts are repaired, the repair fees must also be taken into account.

In the total cost calculation module 134c, the production cost of a product can be calculated using the total assembly cost calculated by the assembly cost calculating module 134a, the assembly loss calculation module 134b, and the total unit prices of the parts.

As described above, the defect rate of the product or parts estimated by the product structure defect rate calculation module 132, the defects estimated by the defect estimation module 133, and the parts or product cost estimated by the product cost calculation module 134, along with the name of the parts or product, are displayed on displaying means 2 or outputting means 5.

The estimation of product or parts defect rates and the like was described for assembly operations, but it would also be possible to use similar methods for processing operations. For processing operations, subdivided standard processing tasks would replace standard assembly tasks, conditions (characteristics) of processing means and processed items would replace active and passive parts, and process task sequences would replace assembly task sequences.

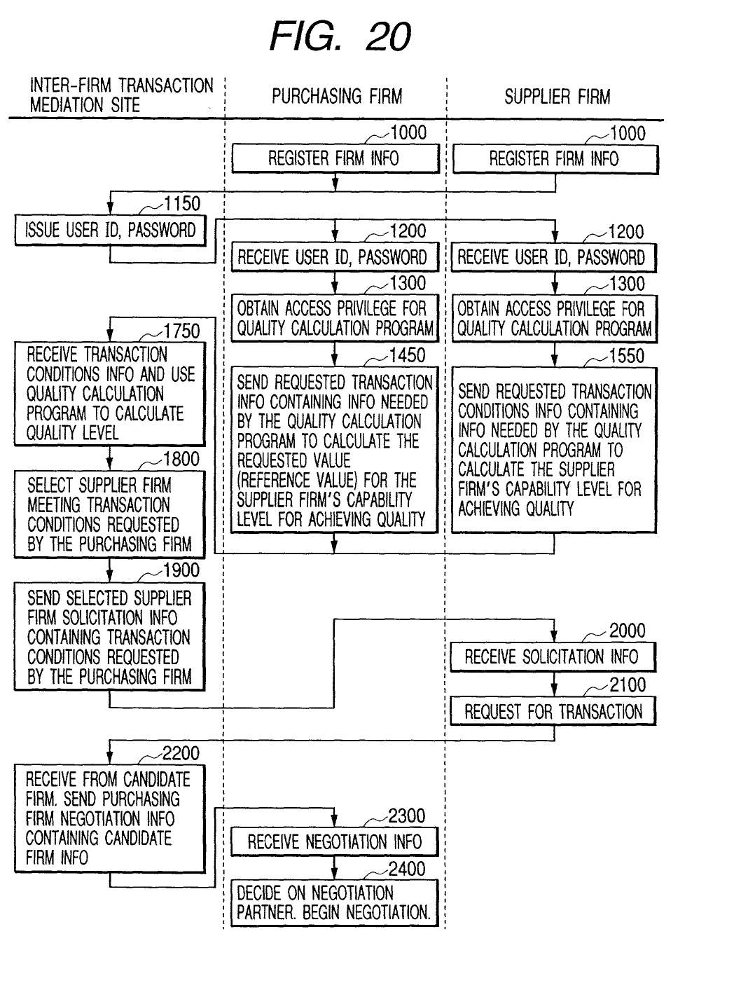

Next, a second embodiment of a method for mediating inter-firm transactions according to the present invention will be described. In the first embodiment described above, an example is presented of a firm desiring a transaction performs quality calculations. However, this can be performed by the inter-firm transaction mediation site. In this case, the flow of operations in the method for mediating inter-firm transactions according to the present invention would be as shown in FIG. 20. More specifically, the differences between this flowchart and the one shown in FIG. 4 are in the operations starting with step 1400 and ending before step 1800 in FIG. 4. The operations performed in this section are as follows. A firm sends the inter-firm transaction mediation site requested transaction conditions information, including information needed by the inter-firm transaction mediation site to calculate quality (step 1450, 1550). This is received by the inter-firm transaction mediation site and quality level indices are calculated by the quality calculation program based on this received information (step 1750). Other operations are the same as in the first embodiment.

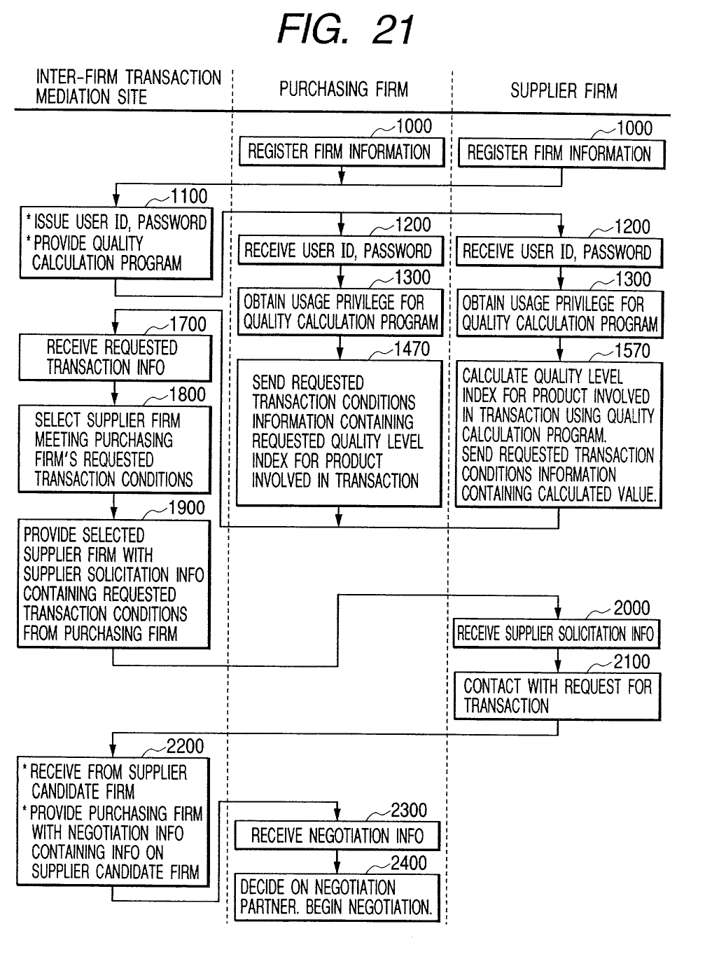

Next, a third embodiment of the inter-firm transaction mediation method according to the present invention will be described. In the first embodiment and the second embodiment described above, the supplier firm selects a transaction partner based on information about quality levels of the supplier firm. In this embodiment, transaction partners are selected based on desired quality levels for the thing involved in the transaction. In this case, the purchasing firm sets up desired quality levels (defect rates: ppm) in the items it wants to purchase based on past performance values and the like, and supplier firms are selected based on these settings. The flow of operations for the inter-firm transaction mediation method according to the present invention in this case is shown in FIG. 21. More specifically, the differences between this flowchart and the one shown in FIG. 4 are in the operations starting with step 1400 and ending before step 1600 in FIG. 4. The operations performed for this section are as follows. The purchasing firm sends the inter-firm transaction mediation site desired transaction conditions information, including information (defect rate) about the desired quality level of the product to be purchased (step 1470). The supplier firm uses the quality calculation program to calculate quality level indices (estimated defect rates) for the products it offers (step 1570). This is received by the inter-firm transaction mediation site (step 1700). The supply firm is selected based on this received information (step 1900). Other operations are the same as in the first embodiment.

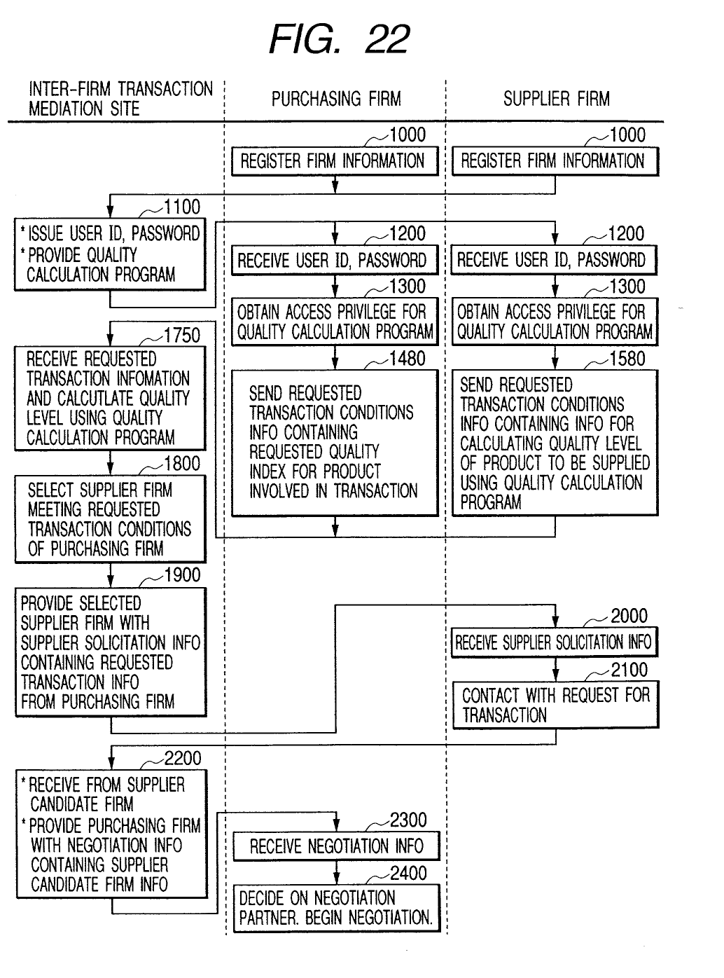

Next, a fourth embodiment of a method for mediating inter-firm transactions according to the present invention will be described. In the third embodiment described above, an example is presented in which the supplier firm itself performs quality calculations. However, this can be done by the inter-firm transaction mediation site instead. In this case, the flow of operations in the method for mediating inter-firm transactions according to the present invention would be as shown in FIG. 22. More specifically, the differences between this flowchart and the one shown in FIG. 4 are in the operations starting with step 1400 and ending before step 1800 in FIG. 4. The operations performed in this section are as follows. The purchasing firm includes information (defect rate) about the desired quality level of the product to be purchased to the inter-firm transaction mediation site (step 1480). The supplier firm includes information needed to calculate quality in desired transactions conditions information sent to the inter-firm transaction mediation site (step 1580). This is received by the inter-firm transaction mediation site and the quality calculation program is used to calculate quality level indices for items offered by the supplier firm based on the received information (step 1750). Other operations are the same as in the first embodiment.

Next, a fifth embodiment of a method for mediating inter-firm transactions according to the present invention will be described. Unlike the embodiments described above, in this embodiment the purchasing firm and the supplier firm exchange information directly through a network rather than going through an inter-firm transaction mediation site.

The following is a more detailed description of this embodiment, with references to figures.

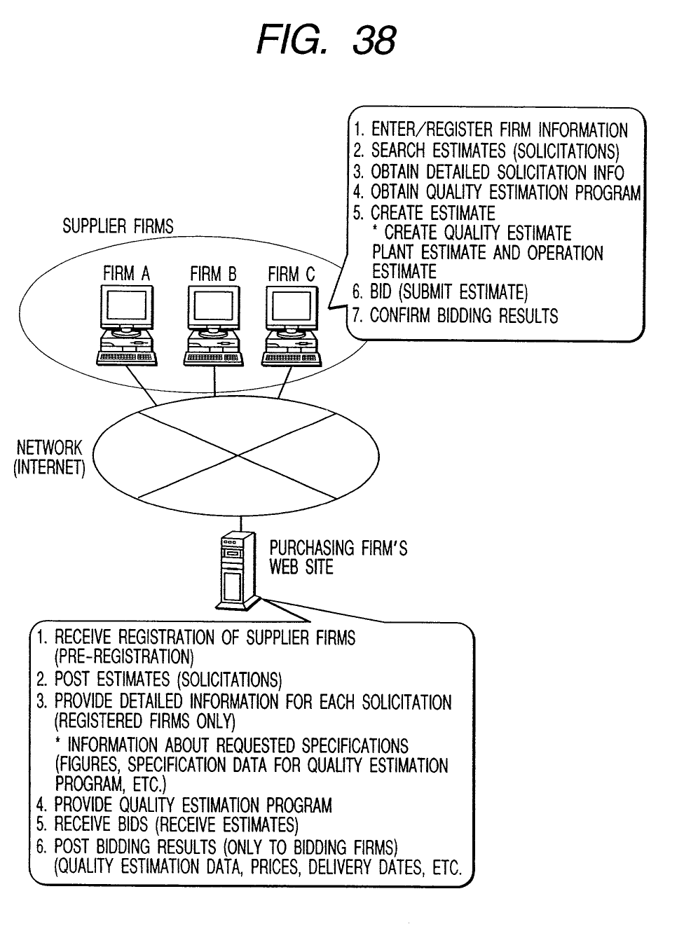

FIG. 38 shows a schematic drawing of the network architecture in this embodiment. The purchasing firm and the supplier firms are connected by way of a network such as the Internet. The purchasing firm posts the product or parts it wishes to purchase (solicitation) on the network, and the supplier firms can make quality estimates regarding this solicitation and enter bids.

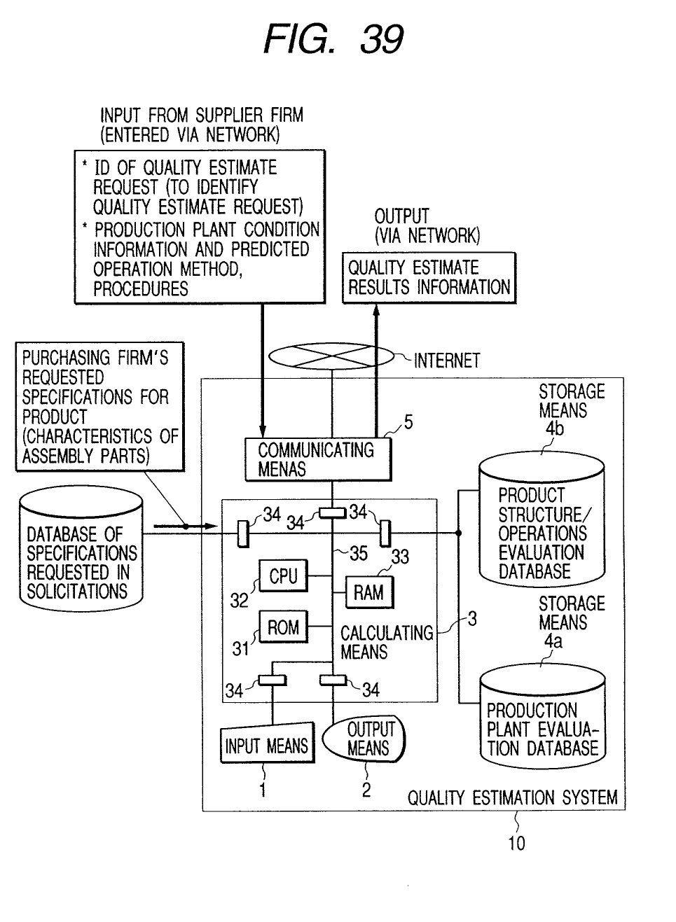

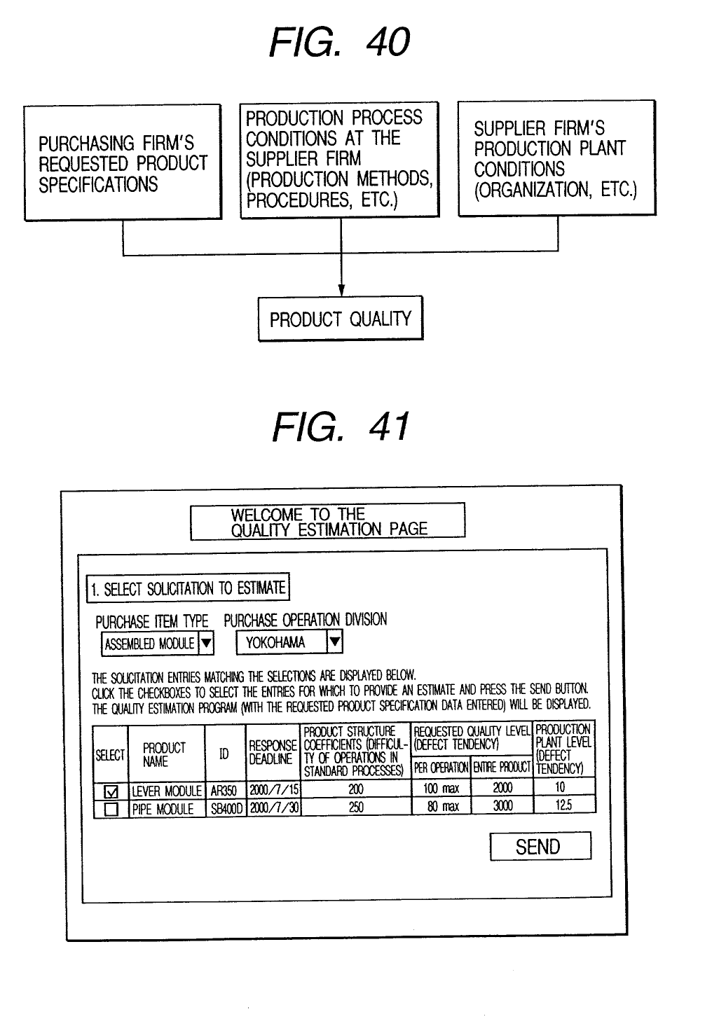

FIG. 39 shows the hardware architecture of a quality estimation system 1000 according to this embodiment. These functions can be provided as functions of the purchasing firm's web site. The present invention also covers providing these functions as part of an ASP of another entity. In this case, the purchasing firm reads requested specification information for the purchase product from a solicitation request specification database. This requested specification information and the quality estimation program and information from the evaluation database are used by the CPU 32 to calculate quality indices desired for the purchase product. These calculated values are posted on the network and serve as the target values for the supplier firms desiring to supply this purchase product. After entering an ID for the quality estimate item, the supplier firms input information about their production plant conditions and the like and perform quality estimation using the quality estimation program. The information structure needed to estimate purchase product quality is shown in FIG. 40. If the purchase product is a general-purpose product, the supplier firms perform quality estimation based on the structure of the purchase product and production process conditions. If the purchase product is a custom product, the quality estimation is performed based on the production plant conditions of the supplier firm and the like. As a result, a specific quality index that can be achieved is calculated.

The results of the quality estimation operation are sent to the supplier firm's system by way of the network. Other elements assigned the same numerals as the elements from FIG. 3 serve the same functions as in FIG. 3. The quality estimation program in this case is formed in the same manner as the evaluation calculation program from the first embodiment.

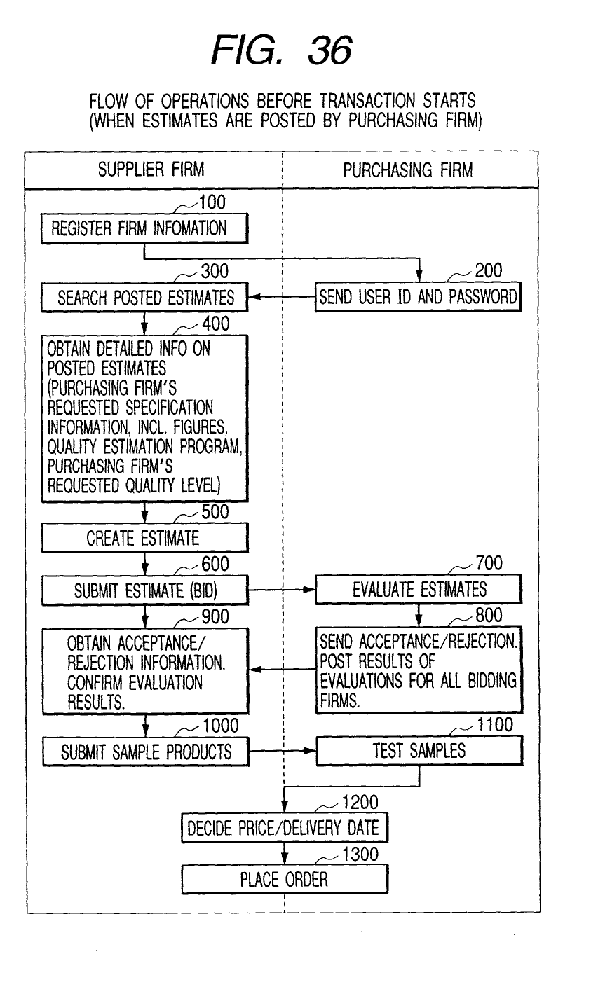

FIG. 36 shows an example of a flow of operations up to determination of a transaction partner. In this case, the supplier firms do public estimates. The following is a description of the steps involved.

(Step 100) Registration of Firm Information

A supplier firm participating in a public estimation for the first time registers its information in advance at the purchasing firm's web site.

(Step 200) Send User ID and Password

A user ID and password are assigned to the firm registering its corporate information in step 100. This allows information about public estimate solicitations to be obtained and allows estimates to be submitted.

(Step 300) Search for Public Estimate From the Supplier Firm

The supplier firm that obtained the user ID and password searches estimate solicitations posted on the web site by the purchasing firm. If there is a solicitation to which the firm wants to bid, the supplier firm obtains detailed information about the public estimate posting in the next step.

(Step 400) Obtain Detailed Information on the Public Estimate Solicitation

The following detailed information regarding the solicitation for which the firm wants to bid is obtained.

Information (including figures) about specifications requested by the purchaser

A quality estimation program

The quality level desired by the purchaser

(Step 500) Supplier Firm Creates Estimate

Based on the specification information requested for the purchase product, the supplier firm makes an estimate of its production line and calculates its own quality estimation results using the quality estimation program which contains at least a plant evaluation calculation program. The resulting data is sent to the purchasing firm's web site by way of the network. Also, by using the product structure evaluation calculation program, composite indices of quality estimates can be calculated for quality estimates of the firms own products.

(Step 600) Supplier Firm Sends Estimates Data (Enters Bid)

The estimates results data from step 500 is sent to the purchasing firm's web site. In addition to the estimates results data, the information sent to the web site can also include delivery date, the desired price, and supply capacity.

(Step 700) Purchasing Firm Evaluates Submitted Estimates

The purchasing firm compares the quality target values for the purchase product calculated earlier with the quality estimates submitted by the supplier firms and selects a firm that meets its conditions.

(Step 800) Contact Supplier Firm Regarding Whether Bid was Accepted or not and Post Evaluation Results for all Bidding Firms.

(Step 900) Supplier Firm Obtains Bid Acceptance Information and Check Evaluation Results

(Step 1000) Selected Supplier Firm Submits Sample Product

(Step 1100) Authorization Test from Purchasing Firm

(Step 1200) Final Determination of Price/Delivery Date

(Step 1300) Purchasing Firm Places Order

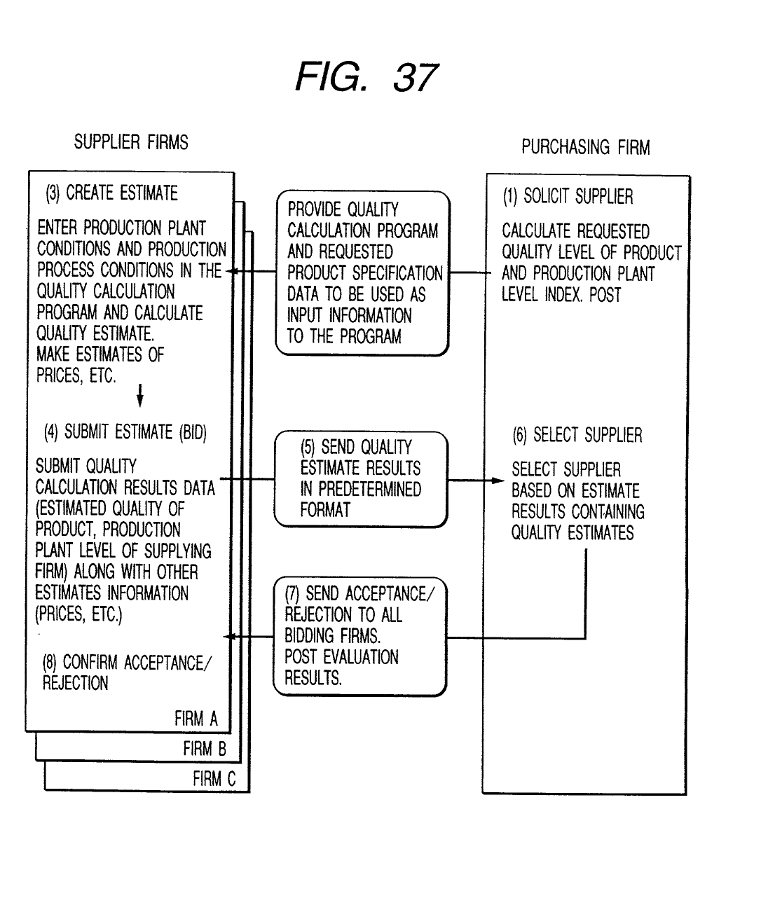

As shown in FIG. 37, the transaction between the purchasing firm and the supplier firm involving the quality estimate can take place with multiple supplier firms. This allows the purchasing firm to determine a transaction partner using specific reference values relating to quality. As a result, product production yield can be improved. The supplier firms can also indicate specific capability levels regarding quality to the purchasing firm to show that high-quality parts can be produced. This improves the chances for receiving orders.

As described above, the quality calculation program or the quality estimation program of the present invention can be used to evaluate a production process in a production plant belonging to the supplier firm. The capability levels of the production plant relating to achieving quality can be indicated with quantitative indices. Also, by using the quality calculation program of the present invention, quantitative evaluations can be made of defect creation for product structures in products developed by the purchasing firm. This provides quantitative indices of defect creation in production of product (production difficulty level). Also, by using the capability level indices relating to quality achievement of a production plant and defect creation indices of a product structure, it is possible to estimate a specific defect rate when a certain product is produced at a certain plant.

In this manner, the quality calculation program of the present invention provides yardsticks for measuring product quality levels and production plant quality levels. This provides quantitative indices for quality levels based on these yardsticks. Furthermore, by combining these indices, defect rates for specific products can be estimated.

In this manner, by using the quality calculation program in a method for mediating inter-firm transactions according to the present invention, the purchasing firm can evaluate defect creation (difficulty of production) of a product to be purchased. Furthermore, lower limits for capability levels relating to quality achievement can be placed on supplier firms' production plants so that a desired defect rate can be obtained. These lower limits can be presented to supplier firms as desired transaction conditions.

Also, by using the quality calculation program of the present invention, the supplier firm can make evaluation calculations of capability levels relating to quality achievement for the production plant of the supplier firm. This can be presented to the purchasing firm as a desired transaction condition to indicate the range of transaction solicitations that the supplier firm can accommodate.

Based on the above, the inter-firm transaction mediation method of the present invention allows quick and appropriate negotiations to take place with a supplier firm having a quality level desired by the purchasing firm. The purchasing firm can purchase high-quality products quickly. The supplier firm can obtain information about transaction solicitations based on its own quality levels.

Also, by using evaluation indices of quality levels, the purchasing firm can improve the design of the product structure to be purchased, and the supplier firm can improve its production plant. The quality calculation program of the present invention can be used in plant inspections by a firms quality assurance division to evaluate production processes in the plant. Also, evaluations can be made on whether plant achieves necessary quality and instructions can be given to improve quality, thereby providing quality improvements.

The quality calculation program of the present invention can be used in design, production, and quality assurance divisions of a firm to provide appropriate defect prevention and defect detection operations.

Also, by using the quality calculation program of the present invention in different development/production processes, defects generated in the production process and defects occurring in the market can be significantly reduced. As a result, the reliability of the products shipped by the supplier firm and the reliability of the products shipped by the purchasing firm can be significantly improved.

With the present invention, a purchasing manufacturer can purchase high-quality items efficiently. Also, the supplying manufacturer is given a specific quality for transactions, so transactions can be selected to match its own quality level. This improves quality for the industry overall by establishing quality targets for transactions and encouraging a desire to improve quality.

What is claimed is:

1. A method for mediating transactions between firms wherein:
means for arithmetic processing selects a supplier firm capable of achieving a product quality level satisfying a product quality level requested by a purchasing firm;
said selection being based on information about conditions for a product quality level requested by said purchasing firm for a product or part to be purchased and information about a product quality level capable of being achieved by said supplier firm for said product or said part; and
negotiation solicitation information is provided to said purchasing firm and a selected supplier firm by way of a network.

2. A method for mediating transactions between firms as described in claim 1 wherein said information about conditions for a product quality level requested by said purchasing firm for a product or part to be purchased includes quality level index data obtained by executing an evaluation calculation program provided by a site belonging to an inter-firm transaction mediator to calculate a quantitative evaluation of product quality levels.

3. A method for mediating transactions between firms as described in claim 1 wherein said information about a product quality level capable of being achieved by said supplier firm for said product or said part includes product quality level index data obtained by executing a quality calculation program provided by a site belonging to an inter-firm transaction mediator to quantitatively evaluate product quality levels.

4. A method for mediating transactions between firms wherein:
means for arithmetic processing selects a supplier firm capable of achieving a production quality level satisfying a production quality level requested by a purchasing firm;
said selection being based on information about conditions for a production quality level requested by said purchasing firm for a firm supplying a product or part to be purchased and information about a production quality level of a supplier firm; and
negotiation solicitation information is provided to said purchasing firm and a selected supplier firm.

5. A method for mediating transactions between firms as described in claim 4 wherein said information about conditions for a production quality level requested by said purchasing firm for a firm supplying a product or part to be purchased includes production quality level index data obtained by executing a quality calculation program provided by a site belonging to an inter-firm transaction mediator to calculate a quantitative evaluation of a production quality level needed to obtain a certain product quality level.

6. A method for mediating transactions between firms as described in claim 4 wherein said information about a quality level of a supplier firm includes production quality level index data obtained by executing a quality calculation program provided by a site belonging to an inter-firm transaction mediator to calculate a quantitative evaluation of a production quality level needed to achieve a certain product quality level.

7. A method for mediating transactions between firms as described in claim 4 wherein:
an inter-firm transaction mediator calculates a production quality level index needed by a supplier firm in order to satisfy a product quality level requested by said purchasing firm for said product or part to be purchased, said calculation being based on information relating to specifications obtained from said purchasing firm of said product or part to be purchased and information about a product quality level requested for said product to be purchased;
said estimated production quality level index needed by a supplier firm being included in condition information for a production quality level of a supplier firm.

8. A method for mediating transactions between firms as described in claim 4 wherein:
an inter-firm transaction mediator calculates a production quality level index of a supplier firm based on production conditions information obtained from said supplier firm; and
said calculated production quality level index of said supplier firm is included in condition information for a production quality level requested of a firm supplying said product or part to be purchased by said purchasing firm.

9. A method for mediating transactions between firms comprising the steps of:
receiving input from a terminal of a purchasing firm containing purchaser request information regarding a product to be purchased, including requested quality information, requested delivery date information, and requested price information, and calculating a composite request index based on said purchaser request information using means for processing arithmetic;
receiving input from a terminal of a supplier firm containing supplier request information regarding a product to be delivered, including production quality level information, possible delivery data information, and requested price information, and calculating a composite ability index based on said supplier request information using means for processing arithmetic;
extracting a supplier firm with a composite ability index fulfilling conditions of said composite request index; and
sending negotiation solicitation information to said supplier firm.

10. An inter-firm transaction method wherein:
a site belonging to a purchasing firm receives input from a terminal belonging to a supplier firm with production quality information regarding a product to be delivered;
said site uses means for processing arithmetic to select a supplier firm with a production quality index fulfilling a quality index requested by said purchasing firm; and
said site sends negotiation solicitation information to a terminal of said selected supplier firm.

11. A method for mediating transactions between firms as described in claim 1 wherein for one or at least two selected supplier firms, at least name and product quality level information is displayed on a display device of a terminal of said purchasing firm.

12. A method for mediating transactions between firms as described in claim 1 wherein name and product quality level information relating to said product or part of another supplier firm is displayed on a display device of a terminal of said purchasing firm.

13. A method for mediating transactions between firms as described in claim 4 wherein for one or at least two selected supplier firms, at least name and product quality level information is displayed on a display device of a terminal of said purchasing firm.

14. A method for mediating transactions between firms as described in claim 4 wherein name and product quality level information relating to said product or part of another supplier firm is displayed on a display device of a terminal of said purchasing firm.
